(19) United States
(12) Patent Application Publication
(10) Pub. No.: US 2009/0254653 A1
(43) Pub. Date: Oct. 8, 2009

(54) Service utilization route output system, management server, service utilization route output method, and service utilization route output program

(75) Inventors: Miyuki Kowa, Fujisawa (JP); Yasuhiko Uchida, Tokyo (JP); Atsushi Shimada, Yokohama (JP); Takao Sato, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/220,603

(22) Filed: Jul. 24, 2008

(30) Foreign Application Priority Data
Apr. 8, 2008 (JP) 2008-100296

(51) Int. Cl. G06F 15/173

(52) U.S. Cl. 709/224

(57) ABSTRACT

A service utilization route output system wherein an integrated search system comprises: a search execution history table storing, in a memory part, access information included in a request sent from a client PC to a search system cluster being service providing servers; a utilization route extracting part extracting a service accessed by the client on the basis of the access information and a service utilization route which is the sequence of the concerned service; a statistical information extracting part computing the number of times of extraction of service utilization routes that are the same as the service utilization route extracted with the utilization route extracting part; and a utilization route display data generating part associating the service utilization route and the number of times of extraction, and generating output information.

### INCORPORATION BY REFERENCE

The present application claims priority from Japanese application JP 2008-100296 filed on Apr. 8, 2008, the content of which is hereby incorporated by reference into this application.

### BACKGROUND OF THE INVENTION

1. Field of the Invention

The present invention is one that pertains to a service utilization route output system, a management server, a service utilization route output method, and a service utilization route output program which, using access history with respect to a plurality of services for each user, are capable of extracting the utilization routes (relationality) of the services and furnishing, to the system administrator, information connected with operational efficiency and service improvements, and information connected with user convenience enhancements.

2. Description of the Related Art

Nowadays, a wide variety of services using search systems, represented by Web services, have gained acceptance. E.g., among the services, there are bus reservation systems, hotel reservation systems, route path search services, and product purchasing services. By using a search system, it gradually becomes possible, without regulating or storing information, to obtain the desired information readily by just disposing it in a searchable environment. In accordance therewith, search systems are becoming something vital to most business operations, so accompanying the fact that operational content is becoming complex, there is a need to execute operations while obtaining information utilizing not only one search system but a plurality of search systems.

In order to progressively further enhance the efficiency of all corporate in-house operations, there is a need to raise the convenience of search systems and to progressively raise the efficiency of work operations using a plurality of search systems.

As prior art, there is the technology of supporting the search so that the user can finally reach the necessary information by accumulating user search history information and displaying synoptically the accumulated information (refer e.g. to JP-A-1995-134717); the technology of searching efficiently, independently of the user's experience, by displaying the accumulated search history on a screen at the time of entering the search conditions (refer e.g. to JP-A-2000-222424); and the technology of saving the search conditions and the search result and, with respect to the aforementioned search conditions and search indications on record, sharing and reusing the corresponding search result and the aforementioned search indication as the search result (refer e.g. to JP-A-1993-48816). Also, there is the technology of generating and displaying search conditions from past access history that coincide with the search objective of the user (refer e.g. to JP-A-2007-293896) and the technology of computing, from the user's history of operating, the user's degree of interest regarding each advertisement and presenting the advertisements in which the user has an interest (refer e.g. to WO2005/006283).

### SUMMARY OF THE INVENTION

The aforementioned prior art is technology that accumulates a user's search history and, by sharing and reusing the search history, aims for an improvement in work efficiency with respect to individual search systems. However, in a case such as executing work reusing a plurality of services, there has been the problem that it was not possible to take into account the relationality between the services and the association of the work objectives and deduce what would be efficient in terms of using which services in which order.

The present invention is an invention for resolving the aforementioned problem and has for its object to furnish a service utilization route output system, a management server, a service utilization route output method, and a service utilization route output program, capable of providing information about service utilization routes which, using the access history for each user with respect to services, extract the relationality between the services, make a service selection, and decide in which sequence the Business Processes (BP) definitions to be executed may be prepared with the system, and with which, also, a computer system can be used and operated in a way that is efficient for the user and the system administrator, by proposing which business process definition to use for the user.

The aforementioned object is attained by providing a function of accumulating the access history (information specifying the sender, information specifying the recipient, and times of access to the service) with respect to services from a client serving as input; a function of extracting, from the access history, the service utilization route followed on the occasion of the user's working with the same objective; and a function of totalizing the extracted results and displaying information suggesting in which sequence which service should be used for operations to become efficient.

The service utilization route output system has a plurality of service providing servers (e.g. search system cluster 5000), providing services on the network and a management server (e.g. an integrated search system 3000) administering the access situation of a client (e.g. a client PC 1000) accessing the aforementioned service providing servers and utilizing the aforementioned services.

The management server is characterized by comprising: a data acquisition request receiving part (e.g. data acquisition request receiving part 3110) receiving a request sent from the aforementioned client to the aforementioned service providing server; a history information storing part (e.g. request analyzing and storing part 3120) associating sender information, recipient information and the reception time of receiving the concerned request, all included in the request received by the aforementioned data acquisition request receiving part, and storing the same as access information in a memory part; a utilization route extracting part (e.g. utilization route extracting part 3530) extracting, on the basis of the aforementioned access information, the service accessed by the aforementioned client and a service utilization route, being the sequence of the concerned service; a statistical information extracting part (e.g. statistical information extracting part 3540) computing the number of times of extraction of a service utilization route that is the same as the service utilization route extracted with the aforementioned service utilization route extracting part; and a utilization route output information generating part (e.g. a data generating part 3550 for utilization route display) associating the aforementioned service utilization route and the aforementioned number of times of extraction and generating output information.

According to the present invention, it becomes possible, by means of extracted service utilization routes, to serve notice to the system administrator of information connected with operational efficiency and service improvement, and information connected with the enhancement of user convenience, so that ascertainment and analysis of the utilization situation of the service becomes simple.

Other objects, features and advantages of the invention will become apparent from the following description of the embodiments of the invention taken in conjunction with the accompanying drawings.

### BRIEF DESCRIPTION OF THE DRAWINGS

FIG. 1 is a general block diagram showing a system of Embodiment 1.

FIG. 2 is an explanatory diagram showing the essential part of the present invention.

FIG. 3 is a flowchart showing the processing of a request execution and result output part.

FIG. 4 is an explanatory diagram showing an example of a user information table.

FIG. 5 is an explanatory diagram showing an example of a search system information table.

FIG. 6 is a flowchart showing the processing of a screen display part.

FIG. 7 is a flowchart showing the processing of a search system utilization route extraction and management part.

FIG. 8 is a flowchart showing the processing of a utilization time extracting part.

FIG. 9 is a flowchart showing the processing of a utilization route extracting part.

FIG. 10 is a flowchart showing the processing of a utilization route extracting part.

FIG. 11 is a flowchart showing the processing of a statistical information extracting part.

FIG. 12 is a flowchart showing the processing of a statistical information extracting part.

FIG. 13 is a flowchart showing the processing of a utilization route display data generating part.

FIG. 14 is an explanatory diagram showing an example of a search execution history table.

FIG. 15 is an explanatory diagram showing an example of a utilization time table.

FIG. 16 is an explanatory diagram showing an example of a utilization route table.

FIG. 17 is an explanatory diagram showing an example of a statistical information table.

FIG. 18 is an explanatory diagram showing a display example of a command prompt screen at the time of executing a utilization route display command.

FIG. 19 is an explanatory diagram showing a display example of a utilization route display screen displaying in descending path length order.

FIG. 20 is an explanatory diagram showing a display example of a utilization route display screen displaying in descending utilization route order.

FIG. 21 is an explanatory diagram showing a display example of a utilization route display screen displaying in descending number of cases order of utilization routes.

FIG. 22 is a general block diagram showing another system of Embodiment 1.

FIG. 23 is an explanatory diagram showing an example of a search request transmission and reception table.

FIG. 24 is an explanatory diagram showing an example of a business application login and logout history table.

FIG. 25 is a general block diagram showing a system of Embodiment 2.

FIG. 26 is an explanatory diagram showing an example of a Web service information table.

FIG. 27 is an explanatory diagram showing an example of a customer information table.

FIG. 28 is an explanatory diagram showing an example of reservation information table.

FIG. 29 is an explanatory diagram showing an exemplification of a display screen of utilization routes of travel sites for males in their twenties.

FIG. 30 is an explanatory diagram showing an exemplification of a display screen of utilization routes of travel sites for females in their twenties.

FIG. 31 is an explanatory diagram showing another exemplification of a display screen of utilization routes of travel sites for females in their twenties.

FIG. 32 is a flowchart showing the processing of a user stratification utilization route display data generating part.

FIG. 33 is a flowchart showing the processing of a display target judgment part.

FIG. 34 is an explanatory diagram showing a display example of a utilization route display screen for conference room reservations, associated with Embodiment 1.

FIG. 35 is an explanatory diagram showing a display example of a utilization route display screen for product purchases, associated with Embodiment 1.

### DESCRIPTION OF THE EMBODIMENTS

Hereinafter, an explanation will be given, with reference to the drawings, regarding the embodiments of the present invention.

### 1. First Embodiment

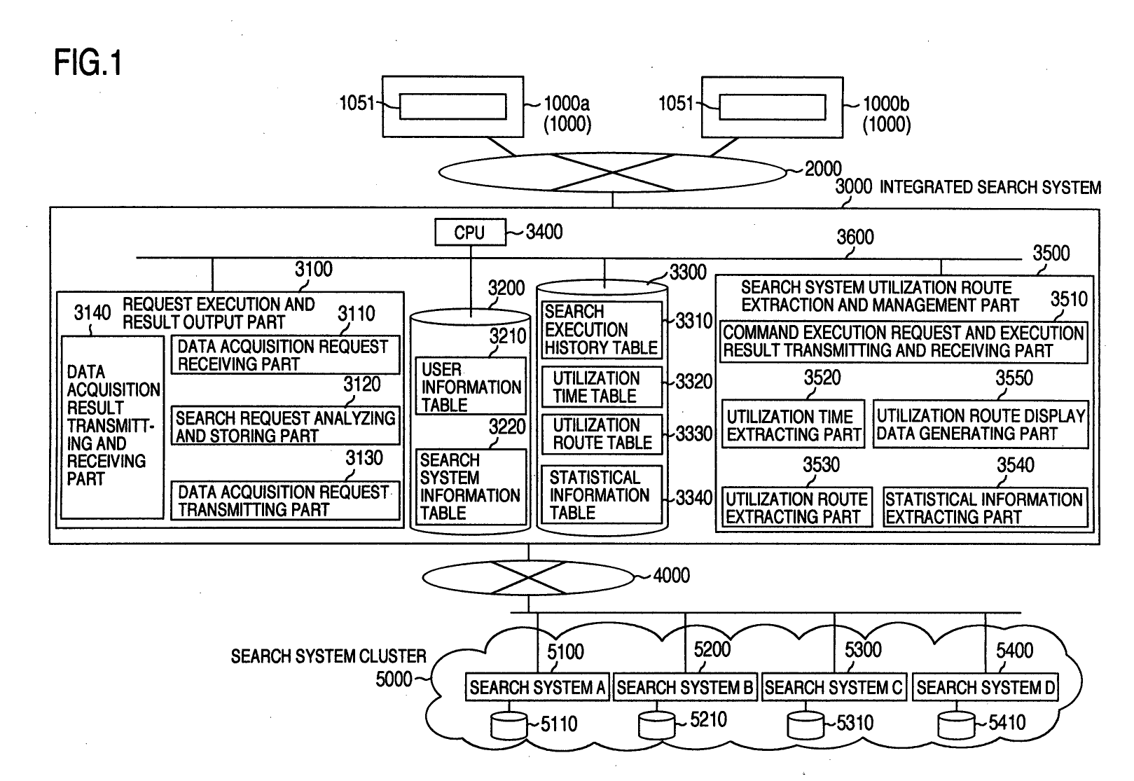

FIG. 1 is a general block diagram showing a system of Embodiment 1. Embodiment 1 is one that is applied to a corporate in-house search system. An integrated search system (management server) 3000, a search system cluster 5000, and a plurality of client PCs 1000 are connected via a network 2000 and a network 4000, such as a LAN (Local Area Network) or a WAN (Wide Area Network) and are in a state of being able to communicate mutually with each other. Search system cluster 5000 has a plurality of search systems, there specifically existing a search system A 5100, a search system B 5200, a search system C 5300, and a search system D 5400. Also, each of the search systems is provided with search object databases 5110, 5210, 5310, and 5410 and is executed by a server, being an information processing device, or the like. Inside the company, there are held a plurality of client PCs 1000, there existing client PCs 1000a used by ordinary users and a client PC 1000b used by the system administrator. Further, PC is an abbreviation for “Personal Computer”.

Integrated search system 3000 is composed of main memories 3100 and 3500, magnetic disk devices 3200 and 3300, a CPU (Central Processing Unit) 3400, and a system bus 3000 for connecting these. CPU 3400 executes various programs (processing part) stored in main memories 3100 and 3500. Main memories 3100 and 3500 are used for holding various processing parts, for executing processes due to integrated search system 3000, and temporary data. Magnetic disk devices 3200 and 3300 are used for storing data generated by integrated search system 3000.

In main memory 3100, there are stored programs of the request execution and result output part. Hereinafter, main memory 3100 will be called request execution and result output part 3100. Request execution and result output part 3100 for the most part transmits requests received from client PCs 1000a to the search system existing in search system cluster 5000 and transmits data acquisition results received from the search system to client PCs 1000a. Request execution and result output part 3100 has a data acquisition request receiving part 3110, a search request analyzing and storing part 3120, a data acquisition request transmitting part 3130, and a data acquisition result transmitting and receiving part 3140.

Also, in main memory 3500, there are stored the programs of search system utilization route extraction and management part 3500. Hereinafter, main memory 3500 will be called search system utilization route extraction and management part 3500. Search system utilization route extraction and management part 3500 receives a search system utilization route output request from a client PC 1000b and transmits the utilization route result of the search system to client PC 1000b. Search system utilization route extraction and management part 3500 has a command execution request and execution result transmitting and receiving part 3510, a utilization time extracting part 3520, a utilization route extracting part 3530, a statistical information extracting part 3540, and a utilization route display data generating part 3550.

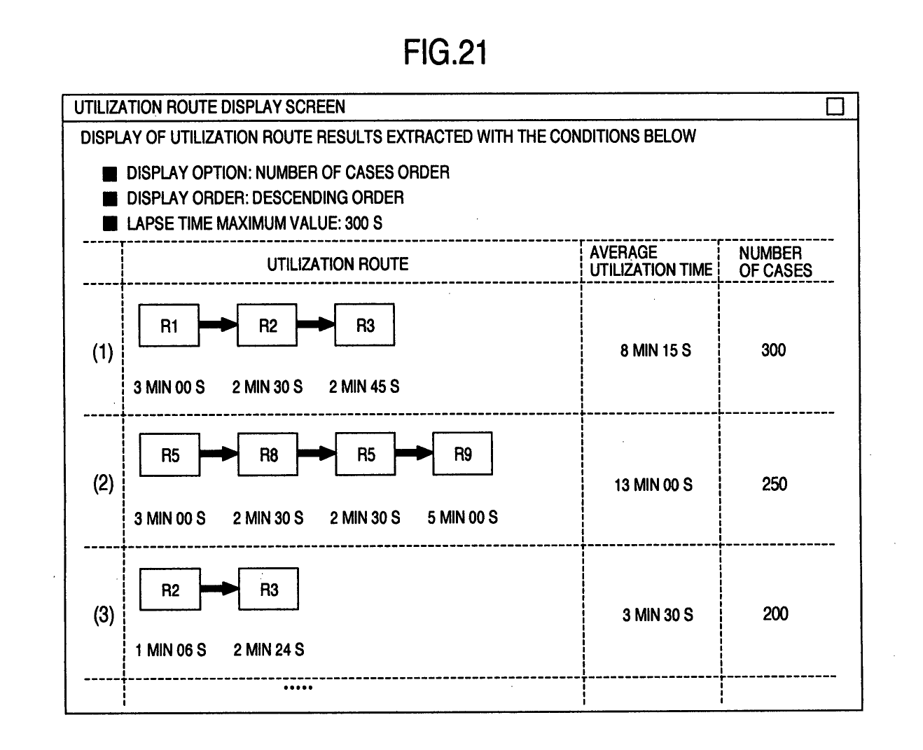

Here, the expression “search system utilization route” refers to a transition from a certain search system to a subsequent search system. E.g., in case, in FIG. 1, a certain user uses search system C 5300 after using search system A 5100 in order to bring one work operation to a successful conclusion, the path from search system A 5100 to the subsequent search system C 5300 becomes a utilization route. An explanation regarding the details will be given in FIG. 21.

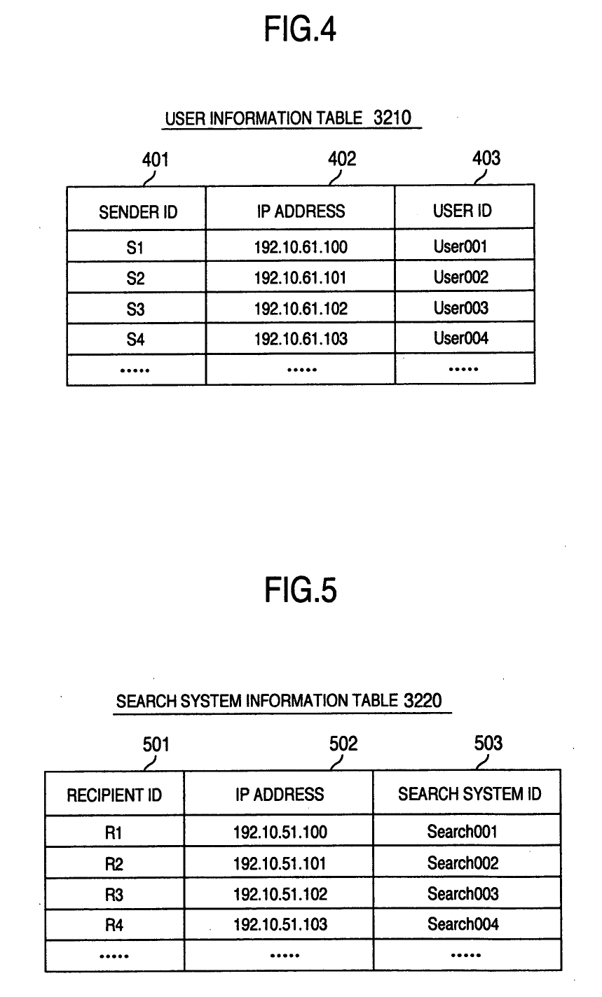

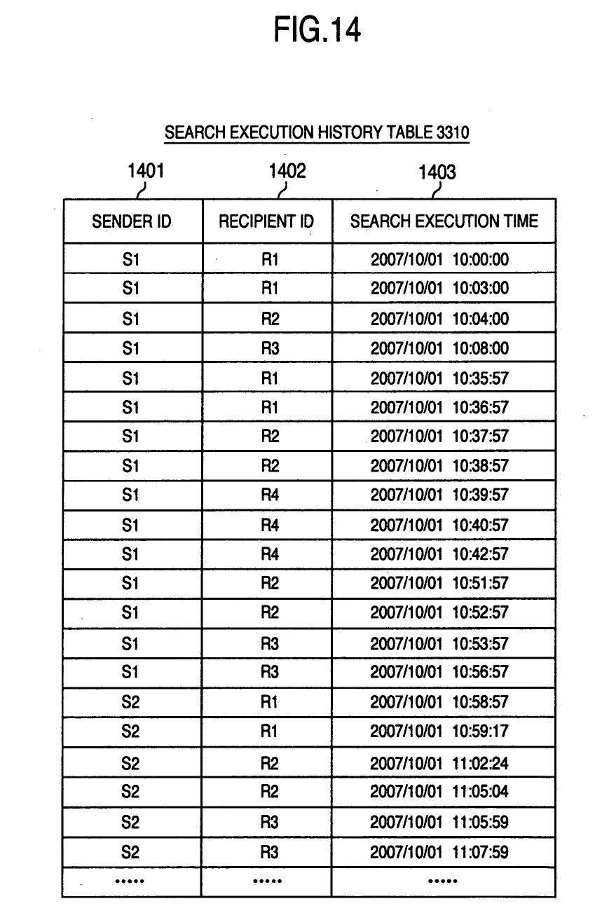

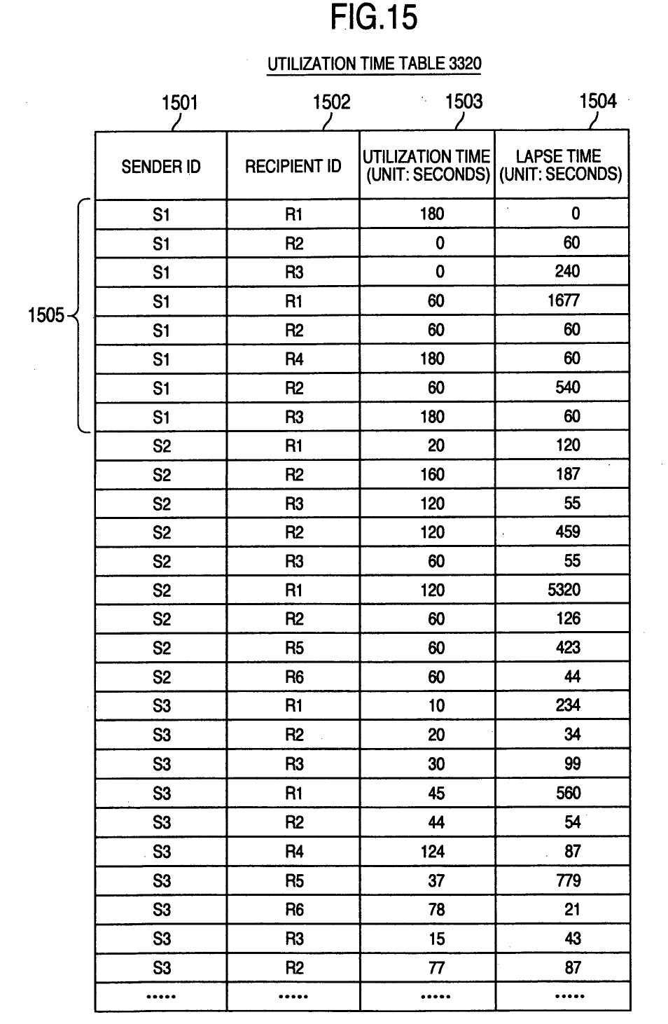

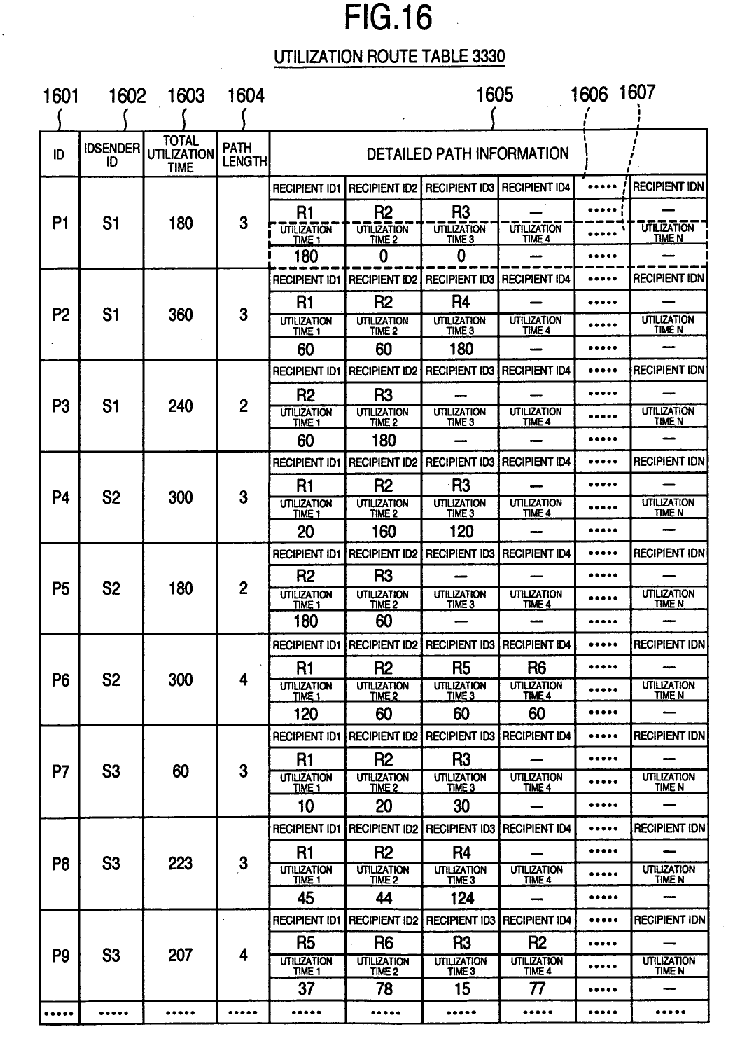

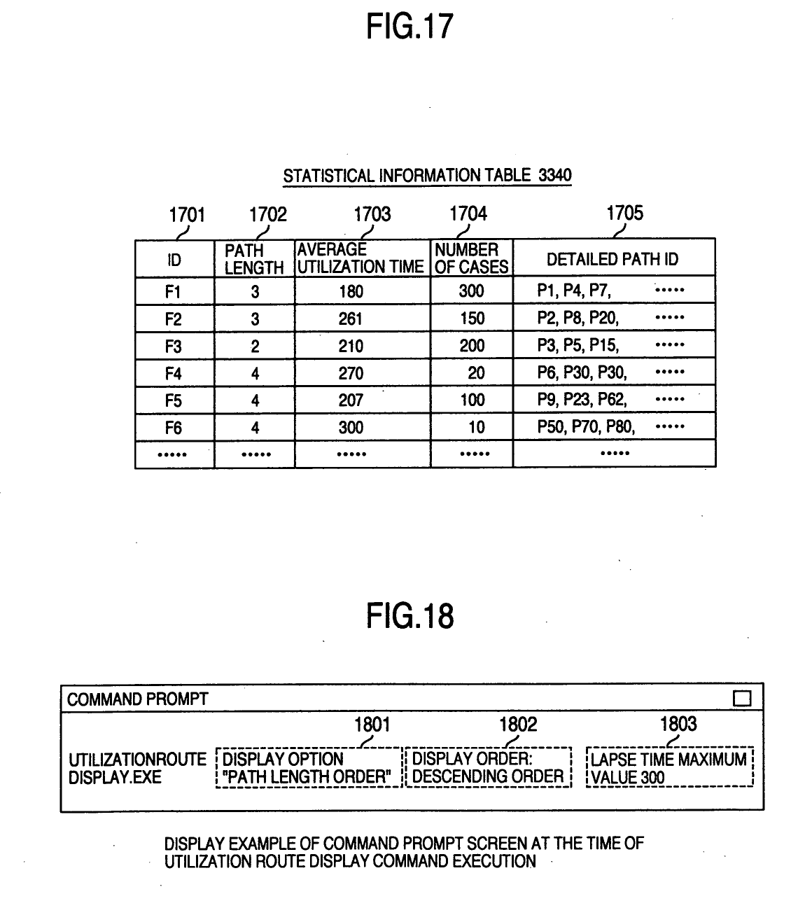

In magnetic disk device 3200, a user information table 3210 (refer to FIG. 4) and a search system information table 3220 (refer to FIG. 5) are stored. Also, in magnetic disk device 3300, there are stored a search execution history table (access information) 3310 (refer to FIG. 14), a utilization time table 3320 (refer to FIG. 15), a utilization route table 3330 (refer to FIG. 16), and a statistical information table 3340 (refer to FIG. 17). Further, the information of user information table 3210 and the information of search system information table 3220 is information that has been defined in advance by the system administrator.

Although not illustrated, client PC 1000 consists of a display illustrating the processing situation and the like, a keyboard inputting commands giving instructions for process execution and the like, a mask giving instructions for process execution from the displayed screen, a CPU (Central Processing Unit) executing various processes, a main memory, a magnetic disk device, a system bus, a communication part, and the like.

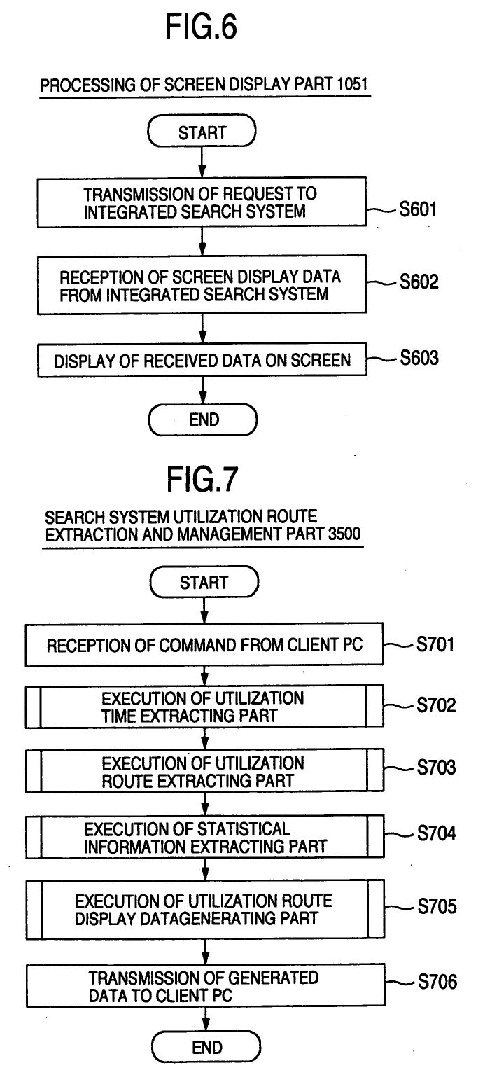

Inside the main memory, there is stored a screen display part 1051, a search request is transmitted via the communication part to integrated search system 3000, and the information generated by the various processing parts of integrated search system 3000 is displayed on the display of client PC 1000. The details of the processes of screen display part 1051 are described in FIG. 6.

Further, in FIG. 1, network 2000 and network 4000 are illustrated as separate networks but it is also possible to have one and the same network. In addition, in FIG. 1, there is illustrated a system configuration with client PCs 1000 and an integrated search system 3000 being arranged in the server, but it is e.g. also possible to leave the functions of client PCs 1000 on the same server as that of integrated search system 3000.

In FIG. 1, there is a plurality of main memories, 3100 and 3500, but it is acceptable to store request execution and result output part 3100 and search system utilization route extraction and management part 3500 within one main memory. Also, there is a plurality of magnetic disk devices, 3200 and 3300, but it is acceptable to store user information table 3210, search system information table 3220, as well as search execution history table 3310, utilization time table 3320, utilization route table 3330, and statistical information table 3340 within one main memory. Moreover, each data item stored on a magnetic disk device may be stored in a main memory.

Next, a summary of the processing of the present invention will be described.

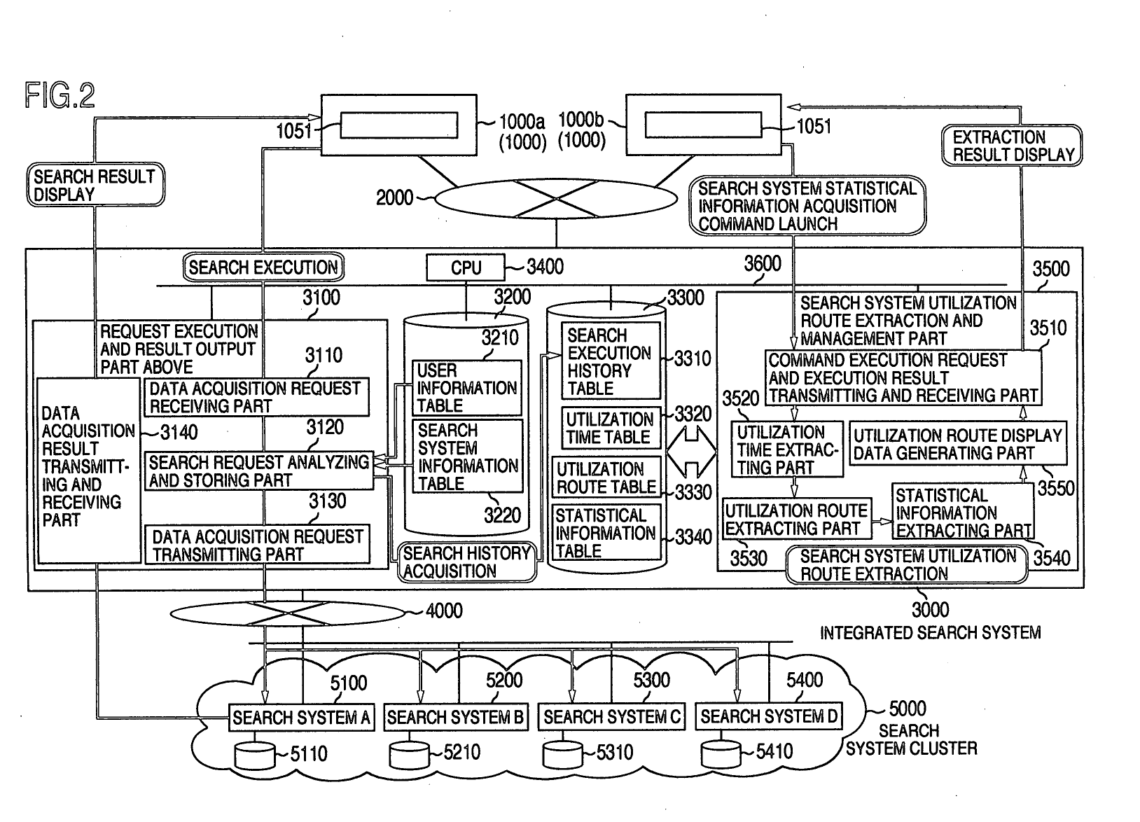

FIG. 2 is an explanatory diagram showing the essential part of the present invention. Using a client PC 1000a, a user makes a request with respect to search system cluster 5000 in order to carry out a specific operation. Data acquisition request receiving part 3110 of request execution and result output part 3100 monitors search execution requests from client PCs 1000a. If data acquisition request receiving part 3110 receives a search execution request, search request analyzing and storing part 3120 acquires the search history from the search request and stores it in search execution history table 3310. Data acquisition request transmitting part 3130 transmits the search execution request in search system cluster 5000 (e.g. search system A 5100). Data acquisition result transmitting and receiving part 3140 transmits the search request from search system cluster 5000 to client PC 1000a.

The system administrator, in order to examine the utilization situation of the user's search system cluster 5000, launches a search system statistical information acquisition command (refer e.g. to FIG. 18) with respect to integrated search system 3000 using client PC 1000b. If command execution request and execution result transmitting and receiving part 3510 of search system utilization route extraction and management part 3500 receives a command being a search system statistical information acquisition request, utilization time extracting part 3520 extracts the utilization time of the search system from search execution history table 3310 (refer to FIG. 14) on the basis of the search history and registers it in utilization time table 3320 (refer to FIG. 15). And then, utilization route extracting part 3530 extracts the utilization route of the search system on the basis of utilization time table 3320 and stores it in utilization route table 3330 (refer to FIG. 16). Statistical information extracting part 3540 stores the statistical information on the basis of utilization route table 3330 and registers it in statistical information table 3340 of the search system. Utilization route display data generating part 3550 generates data for display on the basis of statistical information table 3340 so that they coincide with the acquired command request and transmits the extracted result to client PC 1000b via command execution request and execution result transmitting and receiving part 3510.

Next, an explanation will be given in detail regarding each processing part of integrated search system 3000.

### Request Execution and Result Output Part 3100

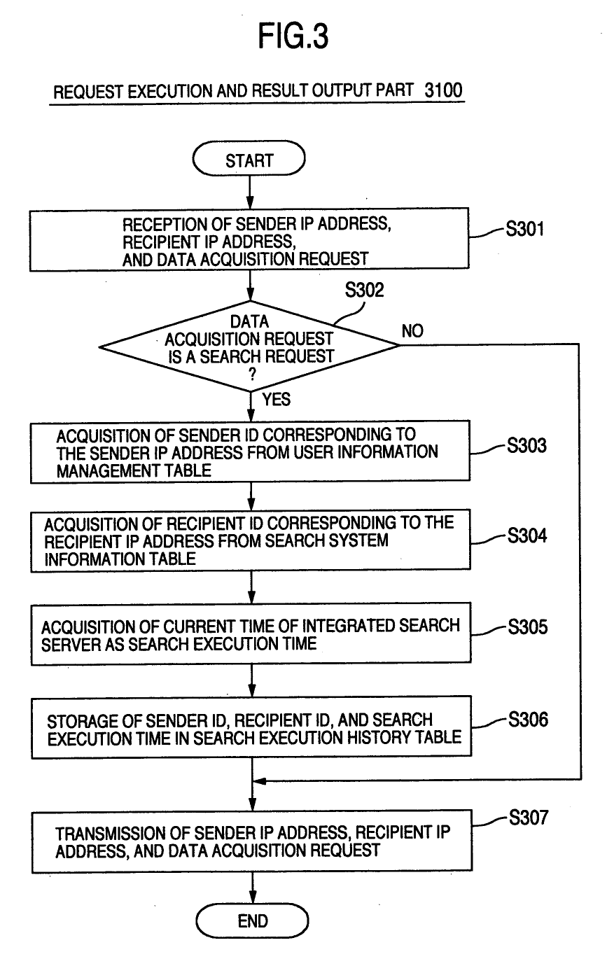

FIG. 3 is a flowchart showing the processing of a request execution and result output part. Data acquisition request receiving part 3110 proceeds, if it receives a search request from screen display part 1051 of a client PC 1000 (S301), to the processing of search request analyzing and storing part 3120. In the search request, there are included the IP address (hereinafter called the sender IP address) of client PC 1000 being the sender, the IP address (hereinafter called the recipient IP address) of a search system being the recipient (e.g. search system A 5100), and the data acquisition request being the content of the request.

Search request analyzing and storing part 3120 first determines whether the received data acquisition request is a “search request” or not (Step S302). In case it is a “search request” (“Yes” in Step S302), the sender ID corresponding to the sender IP address (Step S303) is acquired from user information table 3210 (refer to FIG. 4) and the recipient ID corresponding to the recipient IP address (Step S304) is acquired from search system information table 3220 (refer to FIG. 5).

FIG. 4 is an explanatory diagram showing an example of a user information table. User information able 3210 is composed of sender IDs 401, IP addresses 402 of client PCs being senders, as well as user IDs 403 for identifying client PCs. Specifically, in case IP address 402 is 192.10.61.100, the recipient ID is S1.

FIG. 5 is an explanatory diagram showing an example of a search system information table. Search system information table 3220 is composed of recipient IDs 501, search system IP addresses 502 being recipients, and search system IDs 503 for identifying the search systems. In concrete terms, in case the IP address is 192.10.51.100, the recipient ID is R1.

Returning to FIG. 3, search request analyzing and storing part 3120 acquires the current time of day of the management server of integrated search system 3000 as the search execution time (Step S305), and stores the sender ID, the recipient ID, and the search execution time (Step S306) in search execution history table 3310 (refer to FIG. 14).

FIG. 14 is an explanatory diagram showing an example of a search execution history table. Search execution history table 3310 is composed of sender IDs 1401, recipient IDs 1402, and search execution times 1403. According to FIG. 14, it is seen that e.g. the user having the sender ID S1 accessed recipient ID R1 on Oct. 1, 2007, at 10 hours 0 minutes 0 seconds a.m. and also, if one observes the recipient ID 1402 column, that the recipient ID switches over from R1 to R2 and R3.

Returning to FIG. 3, search request analyzing and storing part 3120 transmits, after storage (Step S306) in search execution history table 3310, the received sender IP address, recipient IP address, and data acquisition request to data acquisition request sending part 3130. Further, in case what is concerned is not a “search request” (“No” in Step S302), the process proceeds to Step S307.

Data acquisition request transmission part 3130 (refer to FIG. 1) transmits (Step S307) the sender IP address, the recipient IP address and the data acquisition request to a recipient IP address search system (e.g. search system A 5100).

Also, although not illustrated in FIG. 3, if data acquisition result transmitting and receiving part 3140 (refer to FIG. 1) receives the request result from recipient IP address search system 5100, it transmits the sender IP address, the recipient IP address, and the data acquisition result to client PCs 1000 with sender IP addresses. Screen display part 1051 of client PCs 1000 will be described with reference to FIG. 6.

FIG. 6 is a flowchart showing the processing of a screen display part. Screen display part 1051 first transmits (Step S601) the request to integrated search system 3000. Next, it receives screen display data from integrated search system 3000 (Step S602). The data received in Step S602 are displayed on the screen (Step S603).

### Search System Utilization Route Extraction and Management Part 3500

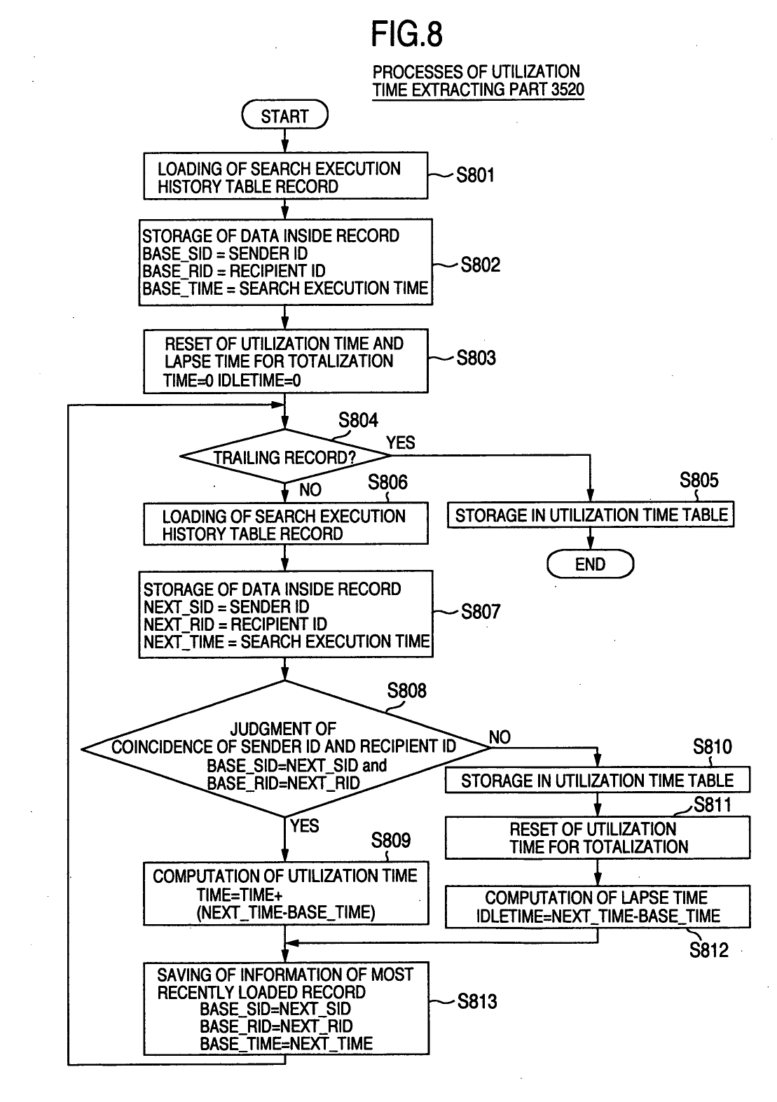

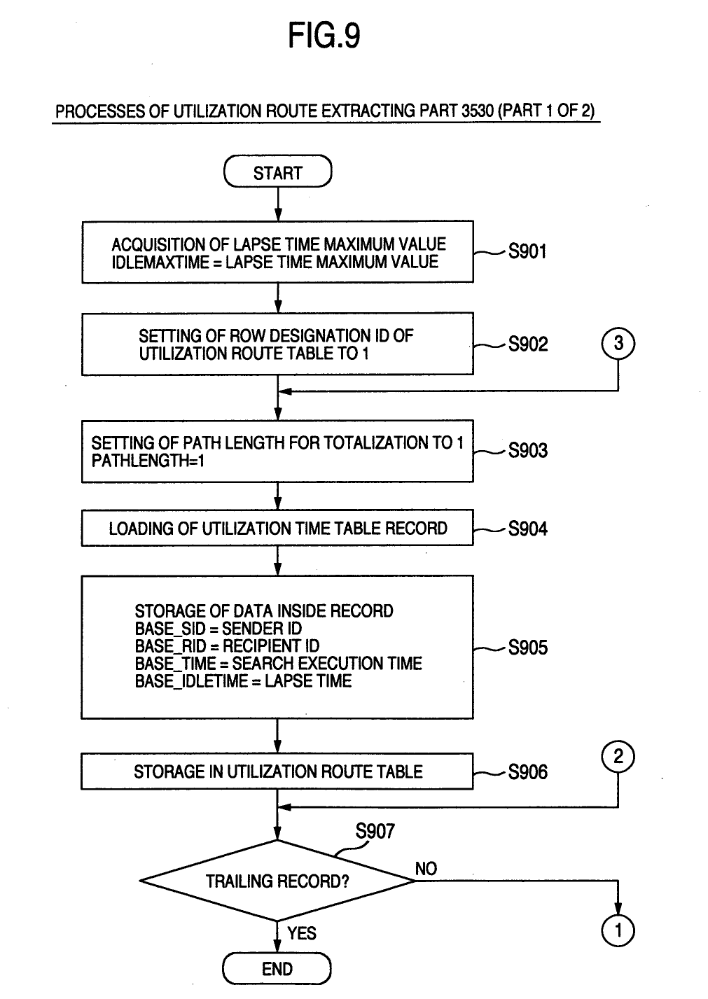

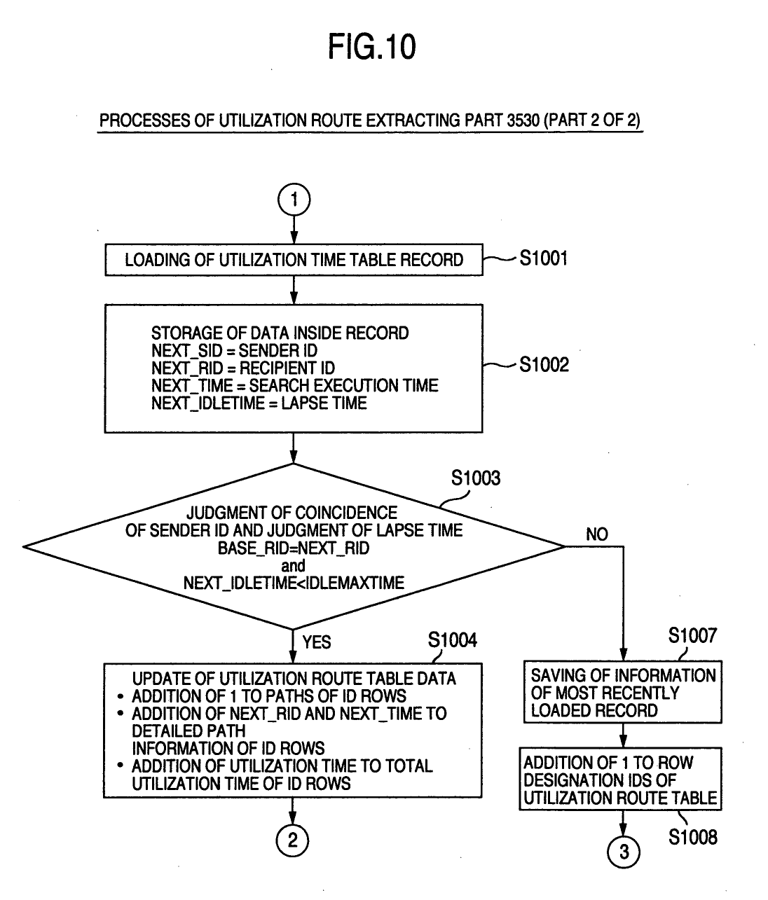

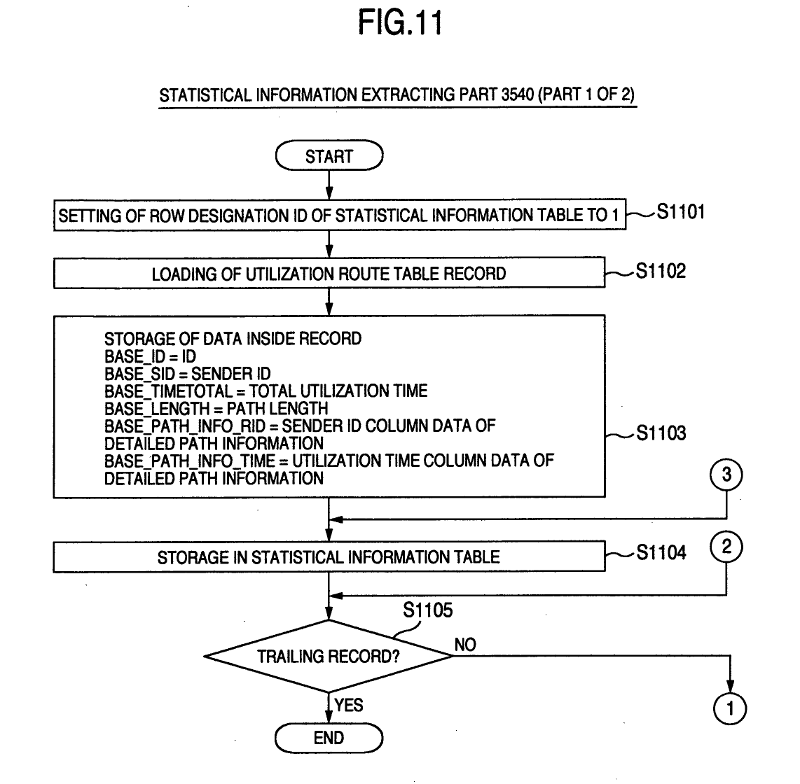

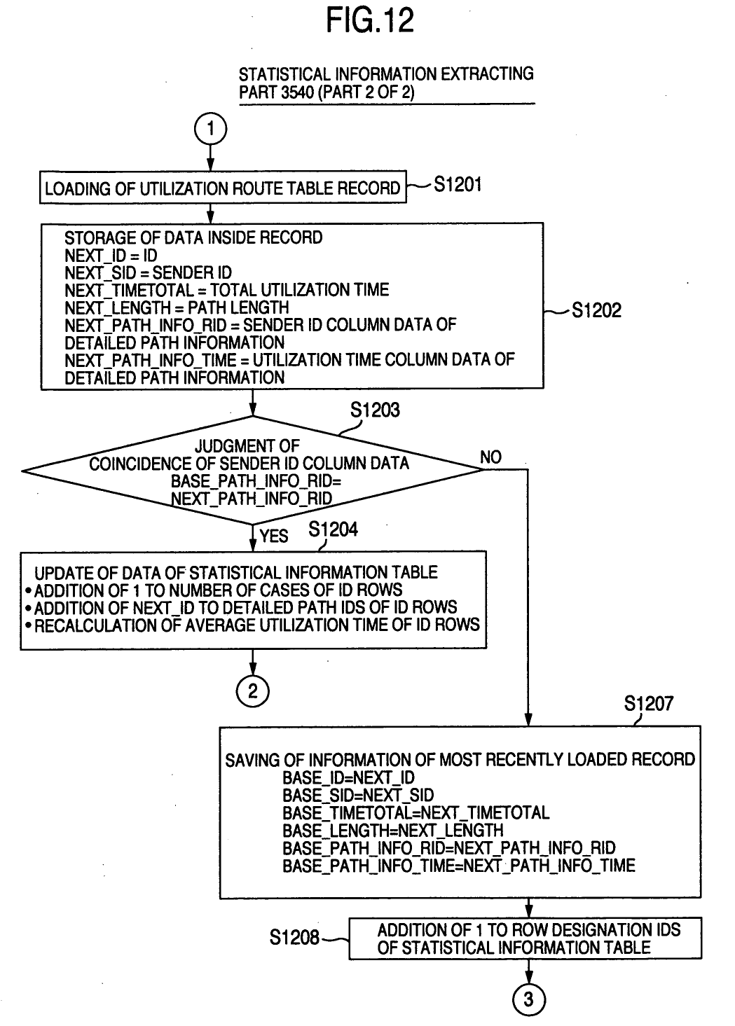

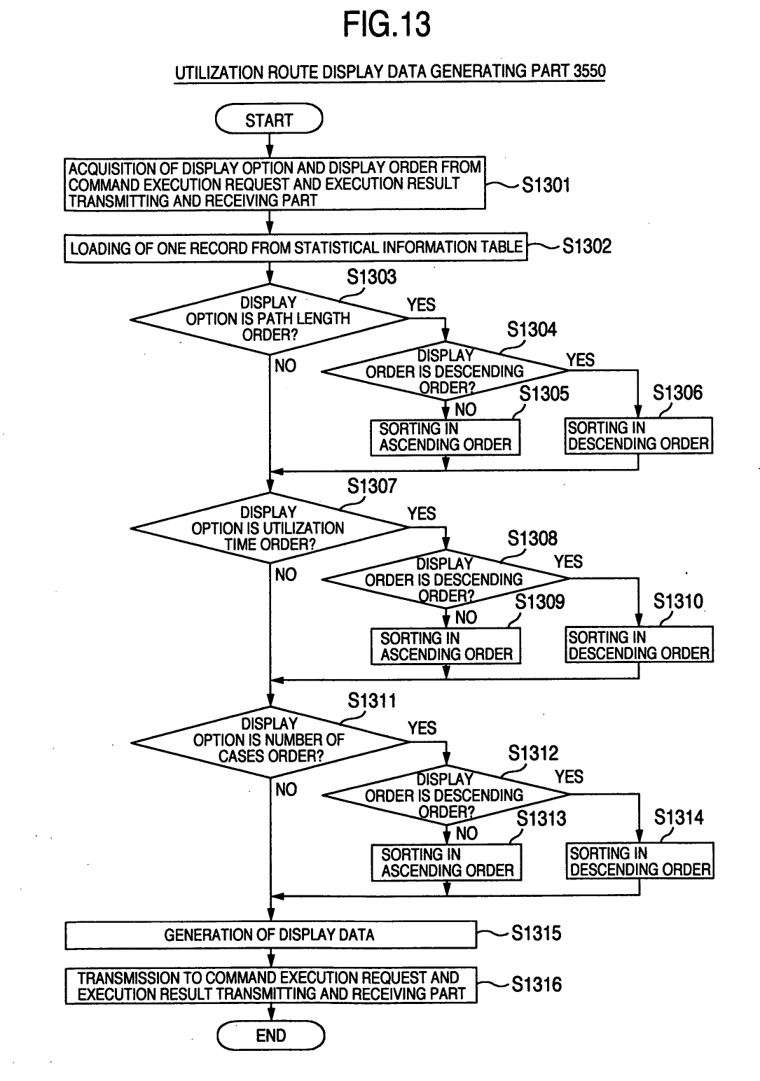

FIG. 7 is a flowchart showing the processing of a search system utilization route extraction and management part. As for search system utilization route extraction and management part 3500, if command execution request and execution result transmitting and receiving part 3510 receives a command indicating an execution request for a utilization route display (Step S701), it executes utilization time extracting part 3520 (Step S702; refer to FIG. 8), executes utilization route extracting part 3530 (Step S703; refer to FIG. 9 and FIG. 10), executes statistical information extracting part 3540 (Step S704; refer to FIG. 11 and FIG. 12), executes utilization route display data generating part 3550 (Step S705; refer to FIG. 13), and transmits the utilization route display data generated in Step S705 by command execution request and execution result transmitting and receiving part 3510 to client PCs 1000 (Step S706). The detailed processing content of Step S702, Step S703, Step S704, and Step S705 will be explained with reference to FIG. 8 to FIG. 13.

### Utilization Time Extracting Part 3520

FIG. 8 is a flowchart showing the processing of a utilization time extracting part. Utilization time extracting part 3520 initially loads one record from search execution history table 3310 (Step S801). The sender ID loaded in Step S801 is stored in variable BASE_SID for holding sender IDs, stores the recipient ID in the variable BASE_RID for holding recipient IDs, and stores the search execution time in the variable BASE_TIME for holding search execution times (Step S802). And then, the utilization time and lapse time for totalization are reset. Specifically, the variable TIME for holding the utilization time for totalization and the variable IDLETIME for holding the lapse time are cleared to “0” (Step S803).

What is called “utilization time” in Step S803 refers to the time from the point at which a specific user first executes a search request with respect to a certain search system until the point at which he last executes a search request and “lapse time” refers to the time from the point at which a specific user executes a search request with respect to a certain search system until the point at which he executes a search request with respect to a separate search system.

In Step S804, it is judged whether or not the record acquired in Step S801 or Step S806 is the trailing record. In case it is trailing (“Yes” in Step S804), the sender ID saved in BASE_SID, the recipient ID saved in BASE_RID, the totalized utilization time saved in TIME, and the totalized lapse time saved in IDLETIME are stored in utilization time table 3320 (Step S805). And then, after execution of Step S805, the process returns to the processing part of the calling party. Utilization time table 3320 will be explained with reference to FIG. 15.

FIG. 15 is an explanatory diagram showing an example of a utilization time table. Utilization time table 3320 is composed of sender IDs 1501, recipient IDs 1502, utilization times 1503, and lapse times 1504. Specifically, in case the sender ID is S1 (rows 1505), it is seen that the recipient ID switches over from R1 to R2 and R3, returns to Rl, and switches over to R2, R4, R2, and R3.

Returning to FIG. 8, in Step S804, in case it is judged that what is concerned is not a trailing record (“No” in Step S804), the next record is loaded from search execution history table 3310 (Step S806). In Step S807, the sender ID loaded in Step S806 is stored in the variable NEXT_SID for holding sender IDs, the recipient ID is stored in the variable NEXT_RID for holding recipient IDs, and the search execution time is stored in the variable NEXT_TIME for holding search execution times.

Next, it is judged whether or not a sender ID stored in Step S802 (BASE_SID) and the sender ID stored in Step S807 (NEXT_SID) coincide, and a recipient ID stored in Step S802 (BASE_RID) and the recipient ID stored in Step S807 (NEXT_RID) coincide (Step S808). In case there is coincidence (“Yes” in Step S808), the difference between the search execution time stored in Step S807 and the search execution time stored in Step S802 is added (Step S809) to the utilization time for totalization (TIME). In case there is no coincidence (“No” in Step S808), the sender ID saved in BASE_SID, the recipient ID saved in BASE_RID, the totalized utilization time saved in TIME, and the totalized lapse time saved in IDLETIME are stored in utilization time table 3320 (Step S810), there is reset (cleared to “0”) the utilization time for totalization, TIME (Step S811), and the difference between the search execution time stored in Step S807 and the search execution time stored in Step S802 is substituted for the lapse time for totalization (Step S812).

After execution of Step S809 or Step S812, the information about the subsequently loaded record is substituted in the variable serving as the base. Specifically, the NEXT_SID information, the NEXT_RID, and the NEXT_TIME information, all stored in Step S807, is substituted, respectively, in BASE_SID, BASE_RID, and BASE_TIME (Step S813). After execution of Step S813, the process returns to Step S804.

### Utilization Route Extracting Part 3530

FIG. 9 and FIG. 10 are flowcharts showing the processing of a utilization route extracting part. Utilization route extracting part 3530 initially acquires, as an argument, the maximum value of the lapse time received in Step S701 by command execution request and execution result transmitting and receiving part 3510 and stores it in the variable IDLEMAXTIME for saving the maximum value of the lapse time (Step S901). Next, “1” is set in the row designation ID of utilization route table 3330 (Step S902). Utilization route table 3330 will be described with reference to FIG. 16.

FIG. 16 is an explanatory diagram showing an example of a utilization route table. Utilization route table 3330 is composed of IDs 1601 designating the utilization route table 3330 rows, sender IDs 1602, total utilization times 1603 being sum totals of the time spent on the utilization routes, utilization route path lengths 1604, and pieces of detailed path information 1605 showing the utilization times in each search system. Further, the expression “path length” refers to a total count of the search systems utilized by the user. In the pieces of detailed path information 1605, being detailed information about paths, there are included recipient ID column data 1606, saving which search systems have been passed through, and utilization time row data 1607, saving the utilization times of the search systems indicated by the recipient IDs.

Returning to FIG. 9, in Step S903, utilization route extracting part 3530 substitutes a “1” in the variable PATHLENGTH for saving path lengths for totalization. Next, one record is loaded from utilization time table 3320 (Step S904) and the loaded sender ID is stored in the variable BASE_SID for saving sender IDs, the loaded recipient ID is stored in the variable BASE_RID for saving recipient IDs, the loaded utilization time is stored in the variable BASE_TIME for saving utilization times, and the lapse time is saved in the variable BASE_IDLETIME for saving lapse times (Step S905). And then, the sender ID saved in BASE_SID, the recipient ID saved in BASE_RID, the utilization time saved in BASE_TIME, and the lapse time saved in BASE_IDLETIME are stored in the corresponding records (ID rows) of utilization route table 3330 (Step S906).

In Step S907, utilization route extracting part 3530 determines whether what is concerned is a trailing record and in case it is trailing (“Yes” in Step S907), the process returns to the processing part of the calling party. In case it is not trailing (“No” in Step S907), the subsequent record is loaded from utilization time table 3320 (Step S1001). The sender ID loaded in Step S1001 is stored in the variable NEXT_SID for saving sender IDs, the recipient ID is stored in the variable NEXT_RID for saving recipient IDs, the utilization time is stored in the variable NEXT_TIME for saving utilization times, and the lapse time is stored in the variable NEXT_IDLETIME for saving lapse times (Step S1002).

Next, it is judged whether a sender ID stored in Step S905 (BASE_SID) and the sender ID stored in Step S1002 (NEXT_SID) coincide or not and, as well, whether the lapse time stored in Step S1002 (NEXT_IDLETIME) is less than the maximum value for the lapse time stored in Step S901 (IDLEMAXTIME) or not (Step S1003).

In Step S1003, in case the conditions are met (“Yes” in Step S1003), one is added to the path length variable PATHLENGTH for totalization, the recipient ID saved in NEXT_RID is added as recipient ID column data 1606 and the utilization time saved in NEXT_TIME is added as utilization time column data 1607 in piece of detailed path information 1605 of the ID rows in utilization route table 3330, and the utilization time saved in NEXT_TIME is added to total utilization time 1603 (Step S1004). After execution of Step S1004, the process returns to Step S907.

In Step S1003, in case the conditions are not met (“No” in Step S1003), the information of the most recently loaded record is substituted (saved) in the variable serving as the base. Specifically, the information of NEXT_SID stored in Step S1002 is substituted in BASE_SID, the information of NEXT_RID is substituted in BASE_RID, the information of NEXT_TIME is substituted in BASE_TIME, and the information of NEXT_IDLETIME is substituted in BASE_IDLETIME (Step S1007). Next, one is added to the IDs being row designation IDs of utilization route table 3330 (Step S1008) and the process returns to Step S903.

### Statistical Information Extracting Part 3540

FIG. 11 and FIG. 12 are flowcharts showing the processing of a statistical information extracting part. Statistical information extracting part 3540 initially sets the row designation IDs of statistical information table 3340 to 1 (Step S1101). Statistical information table 3340 will be described with reference to FIG. 17.

FIG. 17 is an explanatory diagram showing an example of a statistical information table. Statistical information table 3340 is composed of IDs 1701 designating the rows of statistical information table 3340, utilization route path lengths 1702, average utilization times 1703 indicating the average values of the time spent on utilization routes, numbers of items 1704 indicating the number of users having followed the concerned utilization routes, and detailed path IDs 1705 corresponding to the detailed path information of utilization route table 3330. Specifically, in the case of ID F1, it is seen that the path length is 3, the average utilization time is 180 seconds, the number of users having followed R1, R2, and R3 as utilization routes (refer to P1, P4, and P7 of FIG. 16) is 300.

Returning to FIG. 11, one record is loaded from utilization route table 3330 (Step S1102) and the loaded ID is stored in the variable BASE_ID for saving IDs, the sender ID is stored in the variable BASE_SID for saving sender IDs, the total utilization time is stored in the variable BASE_TIMETOTAL for saving total utilization times, the path length is stored in the variable BASE_LENGTH for saving path lengths, the sender ID column data item of the detailed path information is stored in the variable BASE_PATH_INFO_RID for saving sender ID column data, and the utilization time column data item of the detailed path information is stored in the variable BASE_PATH_INFO_TIME for saving utilization time column data (Step S1103). And then, in the ID rows of statistical information table 3340, there are stored the path length saved as the path length in BASE_LENGTH and the total utilization time saved as the average utilization time in BASE_TIMETOTAL, 1 for the number of cases, and the ID saved as the detailed path ID in BASE_ID (Step S1104).

In Step S1105, statistical information extracting part 3540 determines whether or not what is concerned is a termination (trailing record) of utilization route table 3330. In case it is a termination (“Yes” in Step S1105), the process returns to the processing part of the calling party. In case it is not a termination (“No” in Step S1105), the subsequent record from utilization route table 3330 is loaded (Step S1201).

In Step S1202, the ID loaded in Step S1201 is stored in the variable NEXT_ID for saving IDs, the sender ID is stored in the variable NEXT_SID for saving sender IDs, the total utilization time is stored in the variable NEXT_TIMETOTAL for saving total utilization times, the path length is stored in the variable NEXT_LENGTH for saving path lengths, the sender ID column data item of the detailed path information is stored in the variable NEXT_PATH_INFO_RID for saving sender ID column data, and the utilization time column data item of the detailed path information is stored in the variable NEXT_PATH_INFO_TIME for saving utilization time column data.

In Step S1203, it is judged whether a recipient ID column data item of the detailed path information stored in Step S1103 (BASE_PATH_INFO_RID) and the recipient ID column data item of the detailed path information stored in Step S1202 (NEXT_PATH_INFO_RID) coincide or not. In case there is coincidence (“Yes” in Step S1203), one is added to the number of cases of the ID row of statistical information table 3340, NEXT_ID is added to the detailed path IDs, and the average utilization time is recalculated (Step S1204). After execution of Step S1204, the process returns to Step S1105.

In Step S1203, in case it is judged that there is no coincidence (“No” in Step S1203), the information of the subsequently loaded record is substituted (saved) in the variable serving as the base. Specifically, the information of NEXT_ID stored in Step S1202 is substituted in BASE_ID, the information of NEXT_SID is substituted in BASE_SID, the information of NEXT_TIMETOTAL is substituted in BASE_TIMETOTAL, the information of NEXT_PATH_INFO_RID is substituted in BASE_PATH_INFO_RID, and the information of NEXT_PATH INFO TIME is substituted in BASE_PATH_INFO_RID (Step S1207). Next, one is added to the row designation IDs of statistical information table 3340 (Step S1208). And then, the process returns to Step S1104.

### Utilization Route Display Data Generating Part 3550

FIG. 13 is a flowchart showing the processing of a utilization route display data generating part. Utilization route display data generating part 3550 initially acquires the display option and the display order from command execution request and execution result transmitting and receiving part 3510 as arguments (Step S1301). Next, the data of statistical information table 3340 are loaded (Step S1302). And then, it is judged whether the display option acquired in Step S1301 is the path length order or not (Step S1303). In case it is the path length order (“Yes” in Step S1303), it is judged whether the display order acquired in Step S1301 is the descending order or not (Step S1304), and in case it is the descending order (“Yes” in Step S1304), the data loaded in Step S1302 are sorted in ascending path length order (Step S1306), and in case it is not the descending order (“No” in Step S1304), the data loaded in Step S1302 are sorted in ascending path length order (Step S1305). After processing of Step S1305 or Step S1306, the process proceeds to Step S1307. Further, in case the option is not the path length order (“No” in Step S1303), the process proceeds to S1307.

Next, it is judged whether the display option acquired in Step S1301 is the utilization time order or not (Step S1307). In case it is the utilization time order (“Yes” in Step S1307), it is judged whether the display order acquired in Step S1301 is the descending order or not (Step S1308) and in case it is the descending order (“Yes” in Step S1308), the data loaded in Step S1302 are sorted in descending utilization time order (Step S1310), and in case they are not in descending order (“No” in Step S1308), the data loaded in Step S1302 are sorted in ascending utilization time order (Step S1309). After processing of Step S1309 or Step S1310, the process proceeds to Step S1311. Further, in case the option is not the utilization time order (“No” in Step S1307), the process proceeds to Step S1311.

Next, it is judged whether or not the display option acquired in Step S1301 is the number of cases order (Step S1311). In case it is the number of cases order (“Yes” in Step S1311), it is judged whether the display order acquired in Step S1301 is the descending order or not (Step S1312), in case it is the descending order (“Yes” in Step S1312), the data loaded in Step S1302 are sorted in descending number of cases order (Step S1314), and in case it is not the descending order (“No” in Step S1312), the data loaded in Step S1302 are sorted in ascending number of cases order (Step S1313). After processing of Step S1313 or Step S1314, the process proceeds to Step S1315. Further, if the option is not the number of cases order (“No” in Step S1311), the process proceeds to Step S1315.

In Step S1315, using the sorted data, display data for displaying on the display of a client PC 1000 are generated (Step S1315). And then, the data generated in Step S1315 are transmitted to command execution request and execution result transmitting and receiving part 3510 (Step S1316) and processing is ended.

### Utilization Route Display Command

FIG. 18 is an explanatory diagram showing a display example of a command prompt screen at the time of executing a utilization route display command. In the present embodiment, on the occasion of making a utilization route display request, there is a utilization route display command to be issued. The present command is issued from a client PC 1000. The utilization route display command has a display option 1801 designating a utilization route path length order, or a utilization time order, or a number of cases order, a display order 1802 designating a descending or ascending number of cases order, and a utilization route maximum value 1803 used on the occasion of extracting a utilization route. At the time of command execution, it becomes possible, by having the user designate these three arguments, to display the utilization route of the search system in accordance with the viewpoint of the contents of the investigation.

### Utilization Route Display Screen

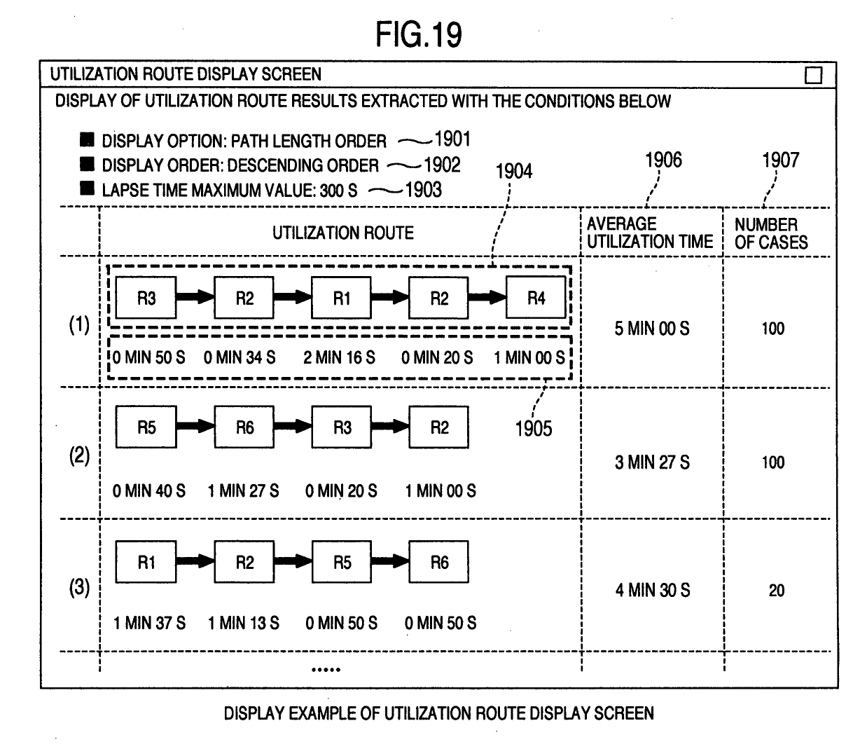

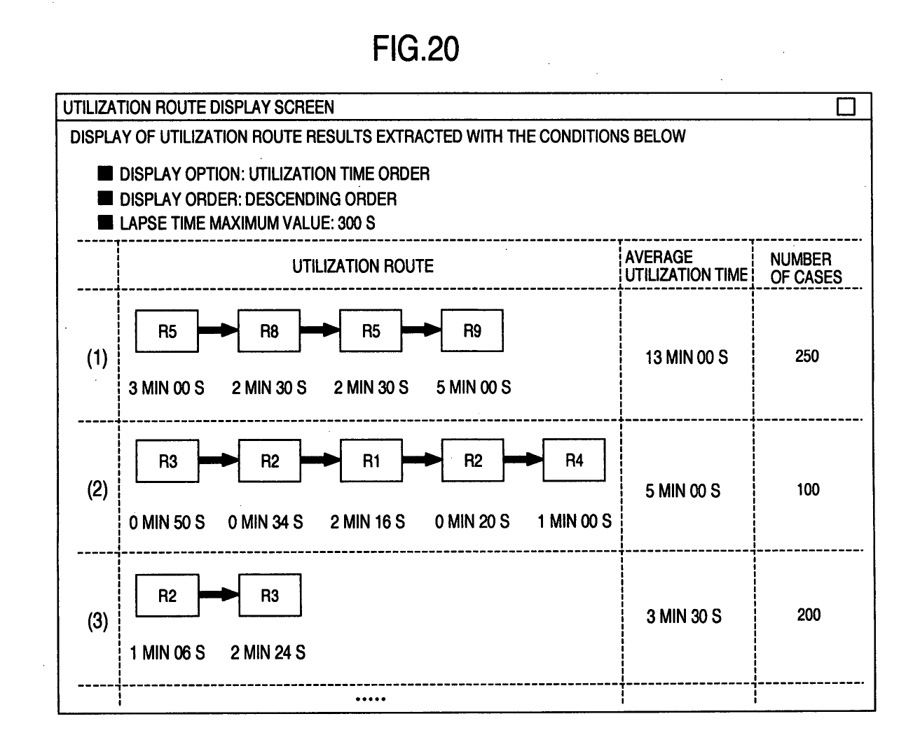

FIG. 19 is an explanatory diagram showing a display example of a utilization route display screen displaying in descending path length order. FIG. 20 is an explanatory diagram showing a display example of a utilization route display screen displaying in descending utilization route order. FIG. 21 is an explanatory diagram showing a display example of a utilization route display screen displaying in descending number of cases order of utilization routes. The utilization route display screen is a utilization route display screen that displays the utilization routes of the search system, if the system administrator inputs a utilization route display command and requests a display of the utilization routes of the search system from a client PC 1000b. With the utilization route display screen, there are displayed a display option 1901 designated as an argument at the time of issuing the display command, a display order 1902, a lapse time maximum value 1903, and the produced result (search system utilization routes 1904, a utilization time 1905 in each search system, average utilization times 1906, and the numbers of cases 1907). Specifically, display option 1901 shown in FIG. 19 is the path length order, and since display order 1902 is the descending order, there are displayed, as the produced result, a case where the path length is 5 (R3→R2→R1→R2→R4) in Row (1), and next, in Rows (2) and (3), cases where the path length is 4. Similarly, display option 1901 shown in FIG. 20 is the utilization time order and display option 1901 of FIG. 21 is the number of cases order.

The system administrator can find out from the utilization route information displayed on the utilization route display screen shown in FIG. 19 that e.g. in the utilization route shown in Row (1) of FIG. 19, that the search system having the sender ID R2 is used twice and also that the utilization route of Row (1) is followed by a very large number of users, as many as 100. Because of this, it follows that the structure of the document used when carrying out a business application or work is poor.

In the search system utilization routes shown in FIG. 20, the utilization times of the search system are displayed in the order of longer times first, and as shown in Row (1) of FIG. 20, time is required for the search with respect to a prescribed objective, so it is possible to conjecture that i.e. that the contents of the search system are not perfected.

In the search system utilization routes shown in FIG. 21, the numbers of cases are displayed in the order of greater numbers of cases first, and in this way, since a large number of individuals are using the search system in the same sequence, it is seen that a system configuration to reduce the user load in cooperation with the concerned search system should be investigated.

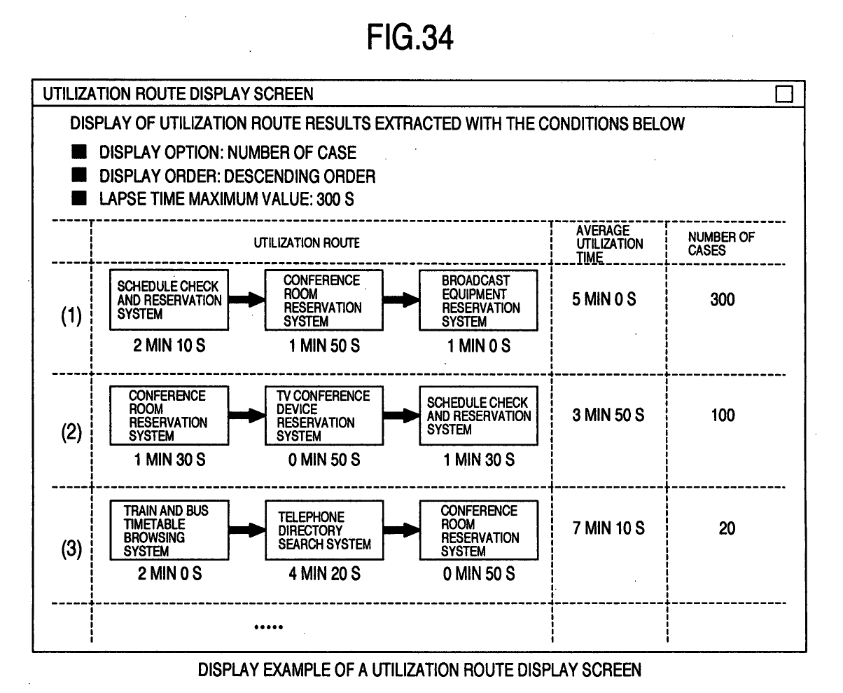

FIG. 34 is an explanatory diagram showing a display example of a utilization route display screen for conference room reservation associated with Embodiment 1. FIG. 34 principally shows the utilization route results of users utilizing a conference room reservation system. As shown in Row (1) of FIG. 34, it is seen that many users, after a search of the conference room reservation system, search for a broadcast device reservation system. As a result hereof, it is possible to infer that users utilizing a conference room reserve a broadcast device. As a future point of improvement of reservation systems, it can be considered that it would be efficient with respect to the users to be able to conjunctively also reserve, at the time of the conference room reservation, a broadcast device that can be used in reservation time slots.

As shown in Row (3) of FIG. 34, the user utilizes a train/bus schedule browsing system before utilizing the conference room reservation system in order to set the time of the conference room and thereinafter utilizes a telephone directory search system. In particular, the utilization time for the telephone directory search system is, at 4 minutes 20 seconds, long compared to the other times. For this reason, it can be inferred that it requires time to investigate the contact addresses of the attendees. From now on, it can be considered that is effective to raise the usability and raise the efficiency of telephone directory search systems.

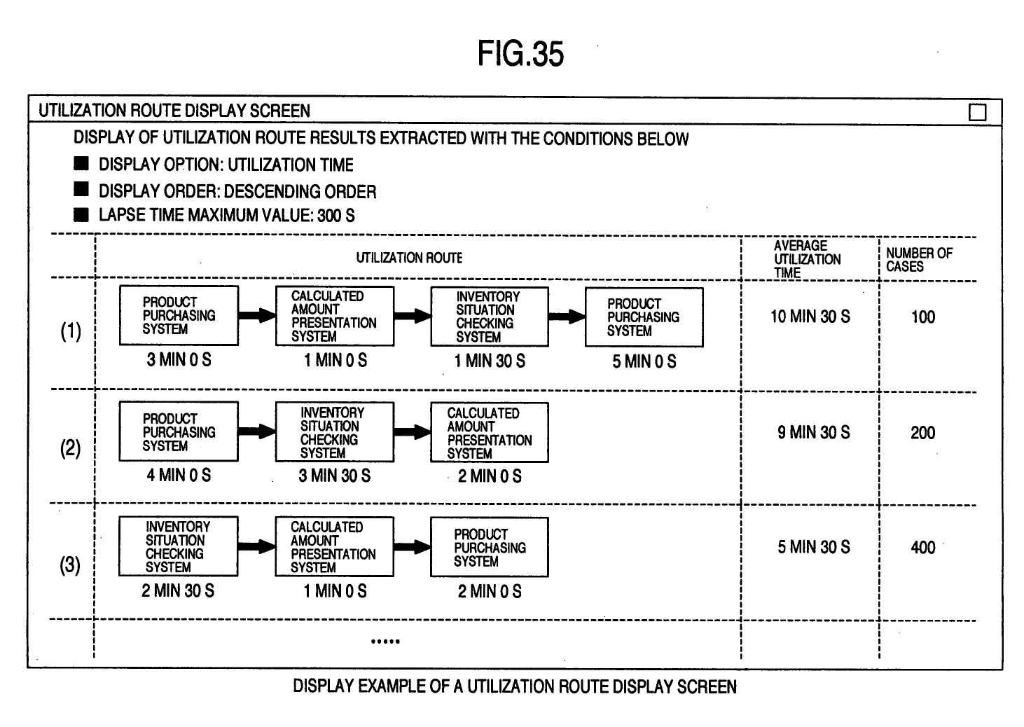

FIG. 35 is an explanatory diagram showing a display example of a utilization route display screen for product purchase associated with Embodiment 1. FIG. 35 mainly shows the utilization route result of a user utilizing a product purchasing system. In Row (1) of FIG. 35, it is seen that there are numerous users using the product purchasing system twice. Also, it is seen that it is necessary to utilize a calculated amount presentation system and an inventory situation checking system for the purpose of the product purchase. For this reason, it can be inferred that it is effective to be able to check the “calculated amount” and the “inventory situation” within the product purchasing system.

Also, in Row (2) of FIG. 35, it is seen that, at 4 minutes, a lot of time is taken for the product purchasing system. For this reason, it can be inferred that the contents of the product purchasing system are not perfected. Moreover, in Rows (2) and (3) of FIG. 35, that the “calculated amount presentation” is carried out after the “inventory check” but, Row (3) has a result with a shorter average utilization time in comparison with Row (2). For this reason, it can be inferred that it is more efficient to create business applications and documents devised to work with the process flow of Row (3).

Conventionally, when considering a policy of enhancing business efficiency, there was a need to implement collection and analysis of a colossal in-house search system log, to carry out hearings with end users using the business applications, and so forth, and enormous time was required for ascertaining and analyzing the current state of the business.

In the search system utilization route extracting system of the present embodiment associated with the present invention, the user (e.g. the system administrator) can readily ascertain, from the utilization route display screens such as shown in FIG. 19, FIG. 20, FIG. 21, FIG. 34, and FIG. 35, the location in the in-house infrastructure where it would be more effective to make improvements, since he can discover the relation between the search systems from the perspective of a certain specific business.

Further, in the present embodiment described this far, there is, in the utilization route extraction command of FIG. 18, which is the object of the present invention, designated the lapse time maximum value 1803 as an argument of the command, the same lapse time maximum value being used as a threshold value when extracting the search system used in the same operation in utilization route extracting part 3530. However, instead of designating the lapse time maximum value, it is also possible to set a certain fixed time, judge the search operations within the certain fixed time to be the search system used within the same business operations, and extract them as the utilization route of the search system.

As an exemplification, in search execution history table 3310 shown in FIG. 14, since, the second row and third row search executions are carried out within 4 minutes after performing the first row search execution in the case of taking the search system threshold value to be “4 minutes”, the search executions from the first and up to the third row are judged to be search requests within the same business operation. By, in the following, similarly carrying out a judgment, the search system utilization routes R1→R2, R3, R1→R2→R4, R2→R3, . . . are extracted.

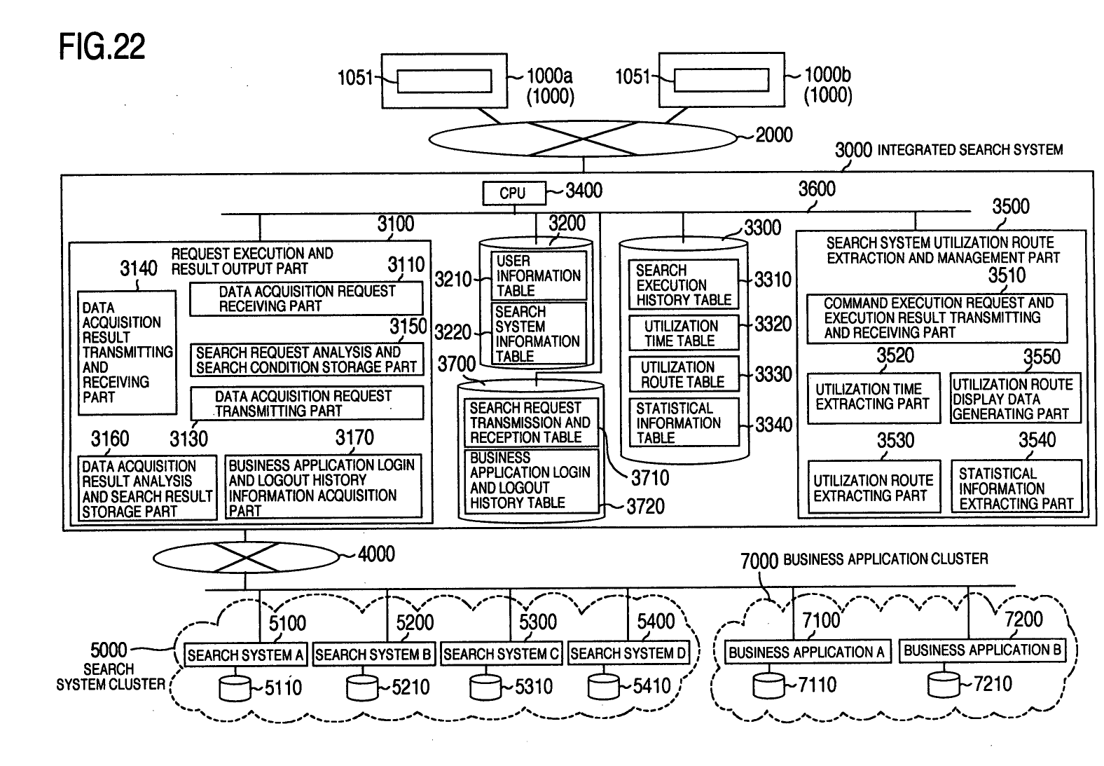

FIG. 22 is a general block diagram showing another system of Embodiment 1. As for the configuration of FIG. 22, there is, in comparison with FIG. 1, provided in request execution and result output part 3100 a search request analysis and search condition storage part 3150 instead of search request analyzing and storing part 3120, a data acquisition result analysis and search result storage part 3160 and a business application login and logout history information acquisition part 3170 are added, and on a magnetic disk 3700, there have been added a search request transmission and reception table 3710, and a business application login and logout history table 3720. Also, in network 4000, there is connected a business application cluster 7000, there specifically being business applications A 7100 and business applications B 7200. In addition, each of the business applications is provided with databases 7110 and 7210 for business operations, which are executed by servers etc. that are information processing devices.

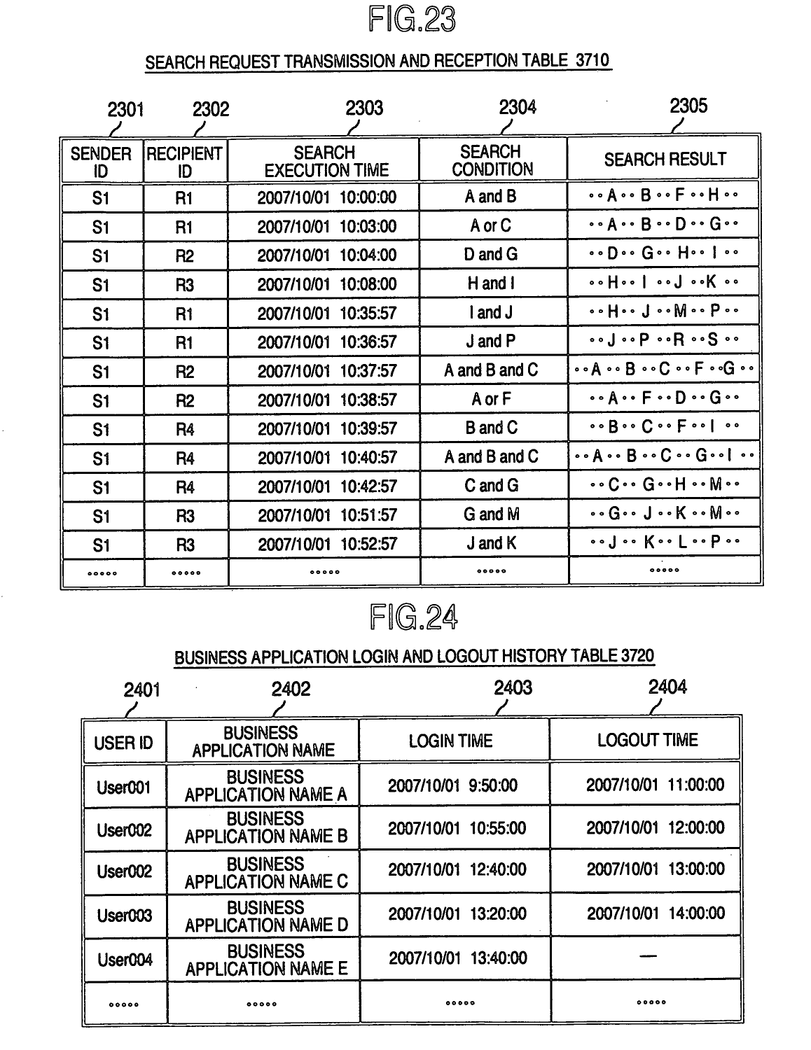

In the embodiment of FIG. 1, search request analyzing and storing part 3120 stores sender IDs 1401, recipient IDs 1402, and search execution times 1403 in search execution history table 3310 (refer to FIG. 14). As against this, in the embodiment of FIG. 22, search request analysis and search condition storage part 3150 acquires from the search request the sender ID, the recipient ID, the search execution time, and the search condition designated at the time of the search request, and stores the same in search request transmission and reception table 3710. Also, data acquisition result analysis and search result storage part 3160 stores the search result in the corresponding search request transmission and reception table 3710 on the occasion of receiving the data acquisition result of the search result from search system cluster 5000. Search result transmission and reception table 3710 will be described with reference to FIG. 23.

FIG. 23 is an explanatory diagram showing an example of a search request transmission and reception table. Search request transmission and reception table 3710 is composed of sender IDs 2301, recipient IDs 2302, search execution times 2303, search conditions 2304, and search results 2305.

According to the present embodiment, since search condition 2304 is included in search request transmission and reception table 3710, search system utilization route extraction and management part 3500 judges a search system in which the search condition for the search system is included in the search request of a previously used search system to be a search system used within the same business operation, so by extracting the utilization route of the search system, it is possible to extract the utilization route taking better into account the relationality between the search systems.

As an exemplification, in the case of search request transmission and reception table 3710 (refer to FIG. 23), since e.g. the character “A” included in the search result of the first row is used in the search result of the second row, the execution results of the first row and the second row are judged to be search requests within the same business operation. However, since none of the characters “J”, “P”, “R”, and “S” included in the search result of the sixth row is used as a search condition of the seventh row, it is judged that the execution results of the sixth and the seventh rows are search requests within different business operations. Even in rows other than those mentioned, by carrying out a similar judgment, the utilization routes R1→R2→R3→R1, R2, R4→R3, . . . are extracted.

Moreover, in the embodiment of FIG. 22, business application login and logout history information acquisition part 3170 acquires the starting time and the ending time with respect to a certain specific business application of client PC 1000 and stores the same in business application login and logout history table 3720. Business application login and logout history table 3720 will be described with reference to FIG. 24.

FIG. 24 is an explanatory diagram showing an example of a business application login and logout history table. Business application login and logout history table 3720 is composed of user IDs 2401 identifying users having used a business application, business application names 2402, login times 2403 showing the time of day at which there was a login into the concerned business application, and logout times 2404 showing the times of day at which logouts were made.

Utilization route extracting part 3530 of the embodiment of FIG. 1 took a fixed idle time, after using one search system and until using the subsequent search system, to be a threshold value, judged it to be a search system used within the same business operation, and adopted the method of extracting the utilization route of the search system. As against this, utilization route extracting part 3530 of the embodiment of FIG. 22, instead of extracting a utilization route by means of a threshold value, consults business application login and logout history table 3720 and extracts the utilization route of the search system. Specifically, the search system used via the business application in the interval from the time that a certain user logged into a certain business application and the time that he logged out is judged to be a search system used within the same business application and by extracting a utilization route of the search system, it is possible to extract the utilization route of the search system with a business operation perspective.

According to the present embodiment, it is possible, with a plurality of corporate in-house search systems being the object, to extract the utilization route of a search system followed by a user, and display the extract utilization route. In this way, there is the effect that the system administrator managing the whole in-house system can, from the relations among the search systems, ascertain where and how in a certain corporate in-house system it would be more effective to make improvements.

### 2. Second Embodiment

Embodiment 2 is an embodiment in which the present invention has been adapted to a Web service on the Internet. In Embodiment 1, there was assumed an in-house utilization and a procedure of extracting the utilization route of an in-house search system was shown, but the fact that it is also possible with the present invention to extract the utilization route of a Web service on the Internet will be explained with Embodiment 2.

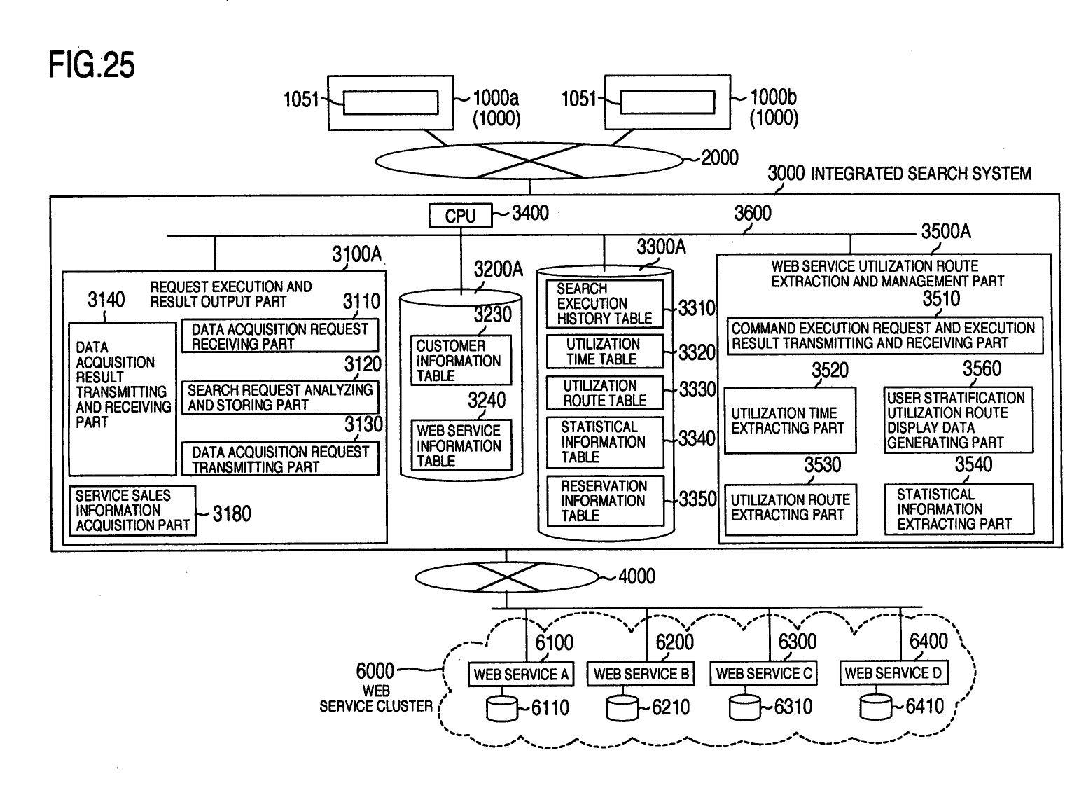

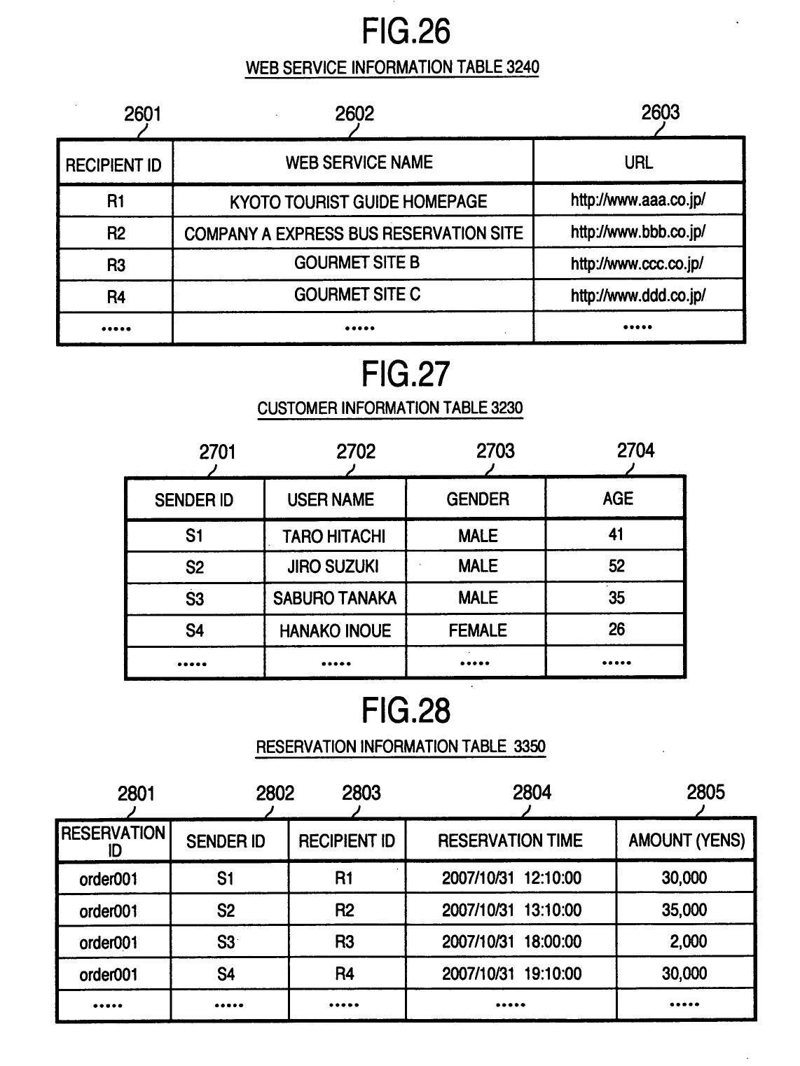

FIG. 25 is a general block diagram showing a system of Embodiment 2. As for the configuration of FIG. 25, in comparison with the configuration of FIG. 1, a service sales information acquisition part 3180 has been added to request execution and result output part 3100A; there have been provided, in magnetic disk device 3200A, a customer information table 3230 (refer to FIG. 27) and a Web service information table 3240 (refer to FIG. 26), instead of user information table 3210 and search system information table 3220; there has been added an reservation information table 3350 (refer to FIG. 28) to magnetic disk 3300A; and instead of search system utilization route extraction and management part 3500, there has been provided a Web service utilization route extraction and management part 3500A. As for Web service utilization route extraction and management part 3500A, in comparison with search system utilization route extraction and management part 3500, there is provided a user stratification utilization route display data generating part 3560 instead of utilization route display data generating part 3550. Also, in network 4000, there is connected a Web service cluster 6000 instead of search system cluster 5000. Web service cluster 6000 has a plurality of Web service systems, there specifically being Web services A 6100, Web services B 6200, Web services C 6300, and Web services D 6400. In addition, each of the Web services comprises databases, 6110, 6210, 6310, and 6410, for providing the services and are executed with servers etc. that are information processing devices. Further, regarding constituent articles that are the same as in the configuration described in FIG. 1, like reference numerals are attached and an explanation thereof is omitted.

FIG. 26 is an explanatory diagram showing an example of a Web service information table. Web service information table 3240 is composed of recipient IDs 2601 for identifying Web services, Web service names 2602, and Web service URLs (Uniform Resource Locators) 2603.

FIG. 27 is an explanatory diagram showing an example of a customer information table. Customer information table 3230 is composed of sender IDs 2701, user names 2702, genders 2703, and ages 2704.

When receiving a product reservation request from client PC 1000, service sales information acquisition part 3180 acquires, from the concerned Web service, a sender ID, a recipient ID, the time at which the reservation request was received, and information about the amount paid by the user at the time of reservation, and stores the reservation information in reservation information table 3350. Reservation information table 3350 will be described in FIG. 28.

FIG. 28 is an explanatory diagram showing an example of a reservation information table. Reservation information table 3350 is composed of reservation IDs 2801, sender IDs 2802, recipient IDs 2803, reservation times 2804, and reservation amounts 2805.

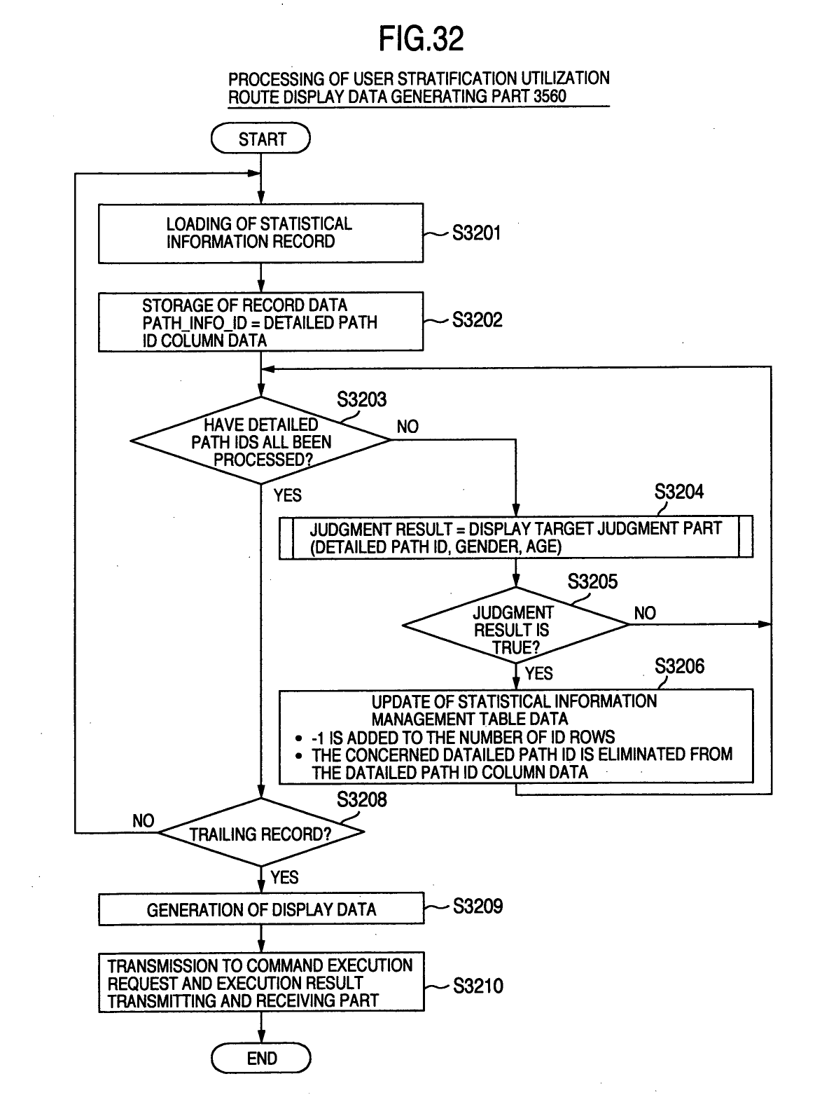

User stratification utilization route display data generating part 3560 can, using the aforementioned information (customer information and Web service information), totalizes the utilization routes related to the Web service, by age group, gender, and the like, similarly to the procedure mentioned in Embodiment 1, and generates display data. The specific procedure will be explained with reference to FIG. 32. Further, the procedures of command execution request and execution result transmitting and receiving part 3510, utilization time extracting part 3520, utilization route extracting part 3530, and statistical information extracting part 3540, associated with Web service utilization route and management part 3500A, are the same as the procedures of Embodiment 1.

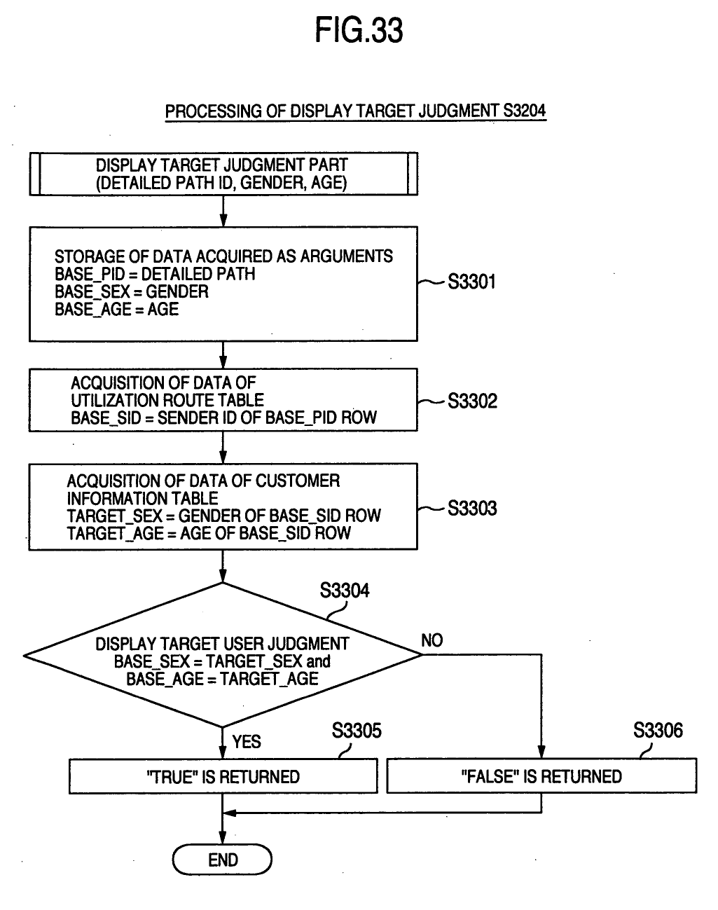

FIG. 32 is a flowchart showing the processing of a user stratification utilization route display data generating part. User stratification utilization route display data generating part 3560 initially loads one record from statistical information table 3340 shown in FIG. 17 (Step S3201). And then, from among the loaded data, it stores detailed path ID column data in the variable PATH_INFO_ID for saving detailed path ID column data (Step S3202). Next, it is judged whether the detailed path IDs acquired in Step S3202 have all been processed or not (Step S3203). In case they have not all been processed (“No” in Step S3203), it transmits the concerned detailed path IDs, the genders targeted for display, and the ages to a display target judgment part (refer to FIG. 33) judging whether the concerned detailed path IDs are targeted for display, and receives the judgment result, <<TRUE>> or <<FALSE>> (Step S3204).

Next, user stratification utilization route display data generating part 3560 judges whether or not the judgment result received in Step S3204 is <<TRUE>> (Step S3205). In case the judgment result is <<TRUE>> (“Yes” in Step S3205), −1 is added to (1 is subtracted from) the number of ID rows of statistical information table 3340 and the concerned detailed path ID is eliminated from the detailed path ID column data (Step S3206). And then, the process returns to Step S3203. In case the judgment result is not <<TRUE>> (“No” in Step S3205), the process returns to S3203.

In Step S3203, in case it was judged that all have been processed (“Yes” in Step S3203), it is judged whether the record loaded in Step S3201 is trailing or not (Step S3208). In case it is not trailing (“No” in Step S3208), the process returns to Step S3201 and in case it is trailing (“Yes” in Step S3208), display data are generated (Step S3209) on the basis of the data of statistical information table 3340 updated in the aforementioned procedure, the data generated in Step S3209 are transmitted to command execution request and execution result transmitting and receiving part 3510 (Step S3210), and the process comes to an end. Further, the detailed processing of the display target judgment part in Step S3204 will be described with reference to FIG. 33.

FIG. 33 is a flowchart showing the processing of a display target judgment part. The display target judgment part first stores the detailed path ID in the variable BASE_PID for saving detailed path IDs, the gender in BASE_SEX, and the age in BASE_AGE, all acquired as arguments from user stratification utilization route display data generating part 3560 (Step S3301). And then, it acquires the sender ID data of the utilization route table BASE_PID row and stores them in the variable BASE_SID for saving sender IDs (Step S3302). It acquires the gender data of the BASE_SID row of customer information table 3230 and stores them in the variable TARGET_SEX for saving genders, and, similarly, acquires the age data of the BASE_SID row of the customer information table and stores them in the variable TARGET_AGE for saving ages (Step S3303). Next, it judges whether the users indicated by the sender IDs acquired in Step S3302 correspond to the users that are targeted for display or not (Step S3304). In the case of correspondence (“Yes” in Step S3304), it returns <<TRUE>> to user stratification utilization route display data generating part 3560 (Step S3305), and in case of no correspondence (“No” in Step S3304), it returns <<FALSE>> to user stratification utilization route display data generating part 3560 (Step S3306).

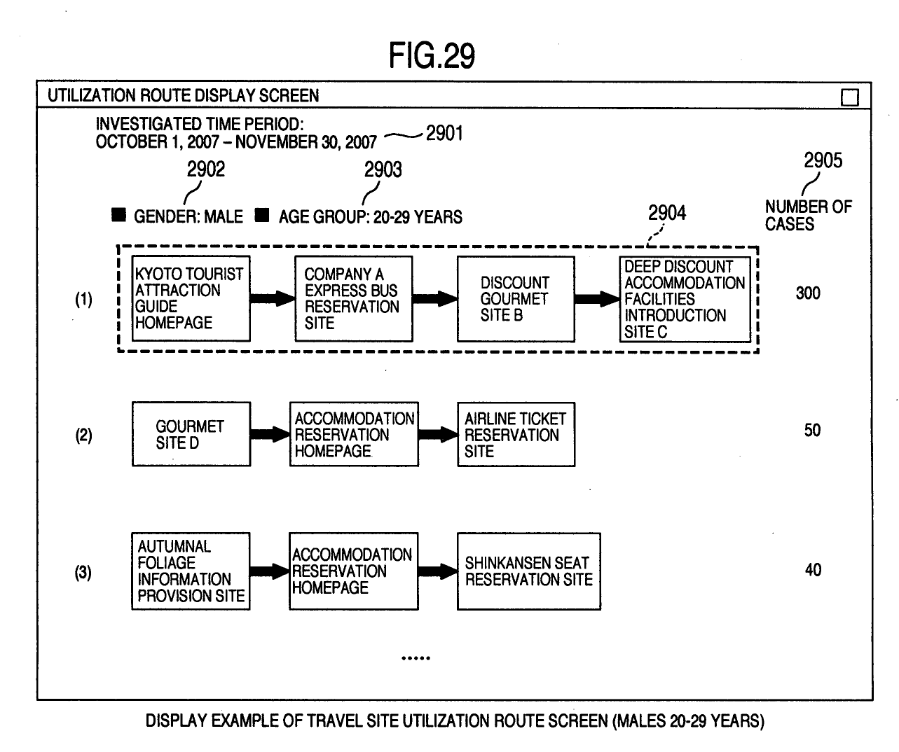

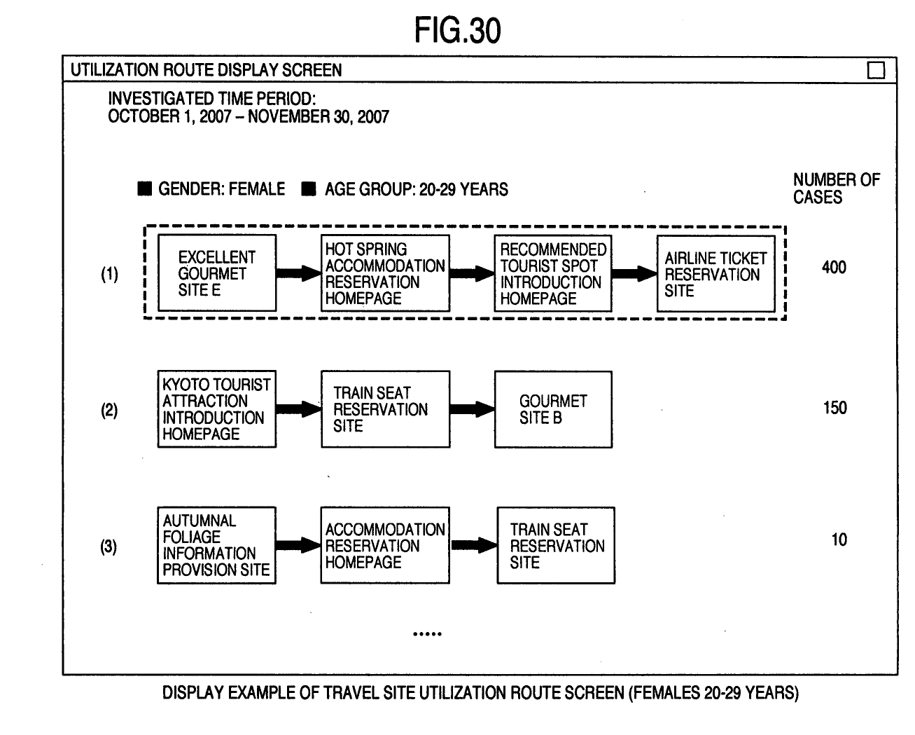

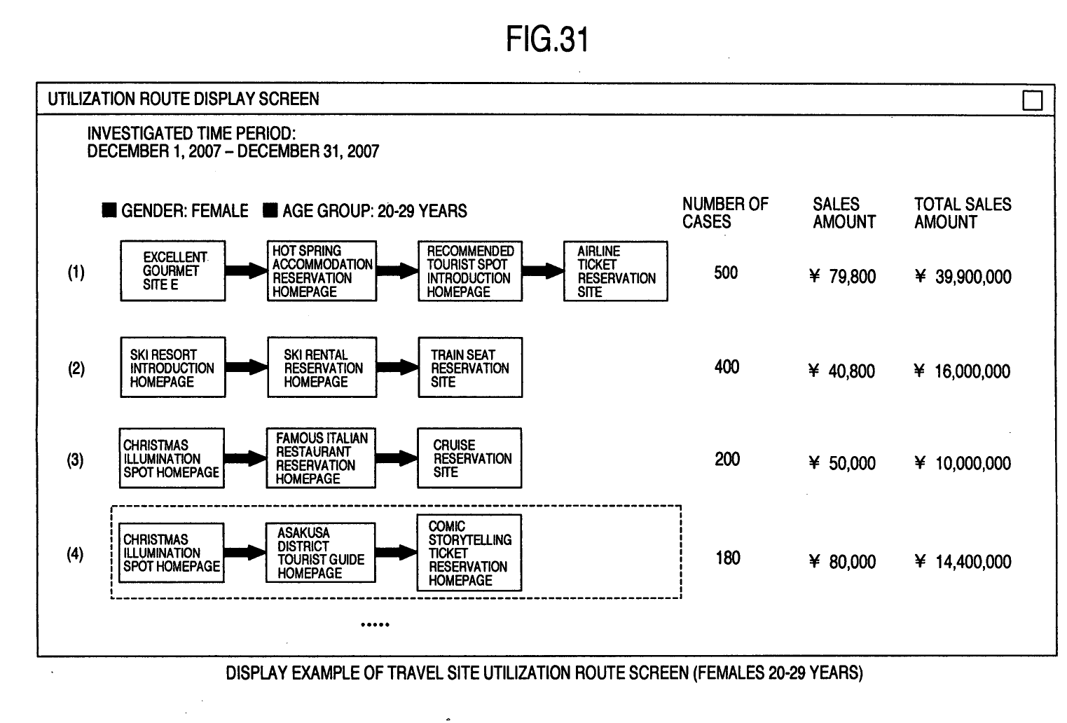

Hereinafter, an explanation will be given with reference to FIG. 29, FIG. 30, and FIG. 31 regarding an exemplification of a utilization route display screen based on extracting Web service utilization routes with the aforementioned procedure.

FIG. 29 is an explanatory diagram showing an exemplification of a display screen of utilization routes of travel sites for males in their twenties. In the example of Row (1) in FIG. 29, access is made to the Kyoto Tourist Attraction Guide homepage (HP) and access is made to the Company A Kanto Bus reservation site, the Discount Gourmet site B, and the Deep Discount Accommodation Facilities introduction site C. From this, it is possible to infer that there is a tendency for males in their twenties to first make a preliminary investigation of basic information about a tourist site, to suppress transportation charges by utilizing an express bus, and to save as much as possible on meal charges and accommodation charges.

FIG. 30 is an explanatory diagram showing an exemplification of a display screen of utilization routes of travel sites for females in their twenties. In the example of Row (1) in FIG. 30, access is made to the Zeppin Gourmet site E, a reservation homepage for accommodation with a hot spring, a recommended tourist spot introduction homepage, and an airline ticket reservation site. From this, it is possible to infer that there is a tendency for females in their twenties to first decide in advance what is that they would like to eat at a tourist site, and further regarding accommodation facilities, that they are fond of inns with hot springs and that they have a tendency thereinafter to obtain information about recommended tourist spots.

FIG. 31 is an explanatory diagram showing another exemplification of a display screen of utilization routes of travel sites for females in their twenties. The utilization routes related to the Web services shown in FIG. 29 and FIG. 30 are totalized by age group and gender and are displayed. In FIG. 31, in addition hereto, on the utilization route display screen, there are displayed including both the sales amount and the total sales amount.

In the example of Row (3) shown in FIG. 31, access is made to a Christmas (Xmas) illumination spot homepage, a famous Italian restaurant reservation homepage, and a cruise reservation homepage. From this, there is a strong tendency for most females in their twenties to pay visits to illumination spots and have meals in Italian restaurants during the Christmas season. Also, in the example of Row (4) shown in FIG. 31, since there are surprisingly many people paying a visit to the Asakusa District of Tokyo and enjoying comic storytelling during the Christmas season and bringing sales of 80,000 yens on average, it can be inferred that there are quite many users spending time in a way that differs from a normal Christmas.

In the present embodiment, since service sales information acquisition part 3180 and reservation information table 3350 are provided, it can be ascertained how much profit is realized for each utilization route by computing, for the Web service utilization routes extracted with the present embodiment, the average value of the total reservation amount spent by users and displaying it together with the utilization routes, so it is also possible to find out that there are contributions to profit beyond anticipation with utilization routes not intended by the Web service provider.

In the present embodiment, it was described that user stratification utilization route display data generating part 3560, using customer information and Web service information, totalizes the utilization routes related to the Web service by age group, gender, and the like and generates display data, similarly to the procedure mentioned in Embodiment 1, but the embodiment is not limited hereto. E.g., the administrator can, by designating predetermined service utilization routes from a client PC 1000b, totalize the designated service utilization routes and generate display data. From this, it is possible to associate the designated service utilization routes and the total sales amounts of the predetermined service utilization routes and to generate display data.

In the present embodiment, since search execution times 1403 are stored in search execution history table 3310, it is possible to extract Web service utilization routes within a certain prescribed time period by also displaying search execution times 1403. Due to this fact, it is possible to ascertain the profit of the utilization routes by season, e.g. around New Year and during the summer holidays.

According to the present embodiment, it is possible, in Web services accompanying searches on the Internet, to extract the Web service utilization routes followed by the users and totalize the extracted utilization routes by age group, gender, and the like, and display them. For this reason, there is the effect it becomes possible for the administrator of an operating company providing Web services, from the relationality among the Web services, to unearth hidden customer needs and to plan and draw up novel schemes devised to be connected with profit increases.

According to the present embodiment, by providing the extracted results to the system administrator, it becomes possible for the system administrator to generate business process definitions on the basis of the extracted results and use computer systems efficiently. The business process definitions may be generated by the system administrator or may be generated by a computer system on the basis of the access history of the extracted services.

Specifically, there is described a system displaying more detailed information on the basis of information such as age, but even in the case where there is no user information like this, even the fact of displaying routes with a large number of cases and displaying the average sales amount/total sales amount for each route becomes beneficial information to the system administrator generating business process definitions.

Also, integrated search system 3000 adds information indicating business process definition candidates, on the basis of the access history of the extracted services, and calculates the sales, for each business process definition, of the services used with the business process definitions, so if the system administrator is notified of the business process definitions having large sales, it becomes possible for the system administrator to preferentially apply definitions with large sales as business process definitions. In case there are, among the business process definition candidates, included services provided by the company itself and services provided by another company, it is possible, by adding the sales of the services provided by the company itself and the sales of the services of the other company to the business process definition candidates, for the system administrator to preferentially choose as business process definitions ways of using the computer system that increase the sales of his own company's services.

Specifically, regarding the utilization route information, by having the color, shape, or the like, of the box indicating the services provided by the company itself vary from that of the box of the services provided by another company, it is possible to make clear to which extent the services of the company itself are used. Also, by placing the box of the services provided by the company itself in a conspicuous place of a portal site or a homepage directly linked to the portal site, there is the effect of increasing the sales of the company itself. Further, if the average sales amount/total sales amount is displayed for each of the services, it is effective in the business process definition generation for increasing the sales of the company itself.

Also, regarding the average sales amount/total sales amount, there is the case of information on individuals being included, but it is also possible that it cannot be procured. In a case like this, it is also possible to prepare a table in which the assumed sales are defined for each service and to obtain the average sales amount/total sales amount for each route based on provisional sales amounts.

It should be further understood by those skilled in the art that although the foregoing description has been made on embodiments of the invention, the invention is not limited thereto and various changes and modifications may be made without departing from the spirit of the invention and the scope of the appended claims.

1. A service utilization route output system having:
a plurality of service providing servers providing services on a network; and a management server which, from the access situation of a client accessing said service providing servers, outputs utilization routes of services accessed by said client;
wherein said management server comprises:
a data acquisition request receiving part receiving a request sent from said client to one of said service providing servers;
a history information storing part associating sender information, recipient information and the reception time of receiving the concerned request, all included in the request received by said data acquisition request receiving part, and storing the same as access information in a memory part;
a utilization route extracting part extracting, on the basis of said access information, the service accessed by said client and a service utilization route being the sequence of said service;
a statistical information extracting part computing the number of times of extraction of a service utilization route that is the same as the service utilization route extracted with said service utilization route extracting part; and
a utilization route output information generating part associating said service utilization route and said number of times of extraction, and generating output information.

2. The service utilization route output system according to claim 1, wherein said utilization route extracting part, when there are accesses from one and the same client within a prescribed time period, extracts service utilization routes taking them to be used within operations having the same objective.

3. The service utilization route output system according to claim 1, wherein:
said management server further comprises a sales information acquisition part associating, and storing in said storage part, said access information included in the request received by said data acquisition request receiving part and sales. information about the service;
said statistical information extracting part, on the basis of said sales information, computes a total service sales amount due to said service utilization route; and
said utilization route output information generating part associates said service utilization route and said total sales amount, and generates output information.

4. The service utilization route output system according to claim 3, wherein said utilization route output information generating part associates the reception time at which said request was received, said service utilization route, and said total sales amount, and generates output information.

5. The service utilization route output system according to claim 1, wherein:
said management server further comprises a sales information acquisition part associating, and storing in said storage part, said access information, included in the request received by said data acquisition request receiving part, and service sales information;
said statistical information extracting part, on the basis of said sales information, computes an average service sales amount due to said service utilization route; and
said utilization route output information generating part associates said service utilization route and said average sales amount of the service, and generates output information.

6. The service utilization route output system according to claim 1, wherein:
said management server further comprises a sales information acquisition part associating, and storing in said storage part, said access information, included in the request received by said data acquisition request receiving part, and service sales information;
said statistical information extracting part computes a sales amount due to a predetermined service utilization route; and
said utilization route output information generating part associates said predetermined service utilization route and the total sales amount of said predetermined service utilization route, and generates output information.

7. A management server managing the access situation of a client accessing a plurality of service providing servers providing services on a network and utilizing said services, wherein said management server comprises:
a data acquisition request receiving part receiving a request sent from said client to one of said service providing servers;
a history information storage part associating, and storing as access information in a memory part, sender information, recipient information, and the reception time at which said request was received, all included in the request received by said data acquisition request receiving part;
a utilization route extracting part extracting, on the basis of said access information, the service accessed by said client and a service utilization route being the sequence of said service;
a statistical information extracting part computing the number of times of extraction of service utilization routes being the same as the service utilization route extracted by said utilization route extracting part; and
a utilization route output information generating part associating said service utilization route and said number of times of extraction, and generating output information.

8. The management server according to claim 7, wherein said utilization route extracting part, when there are accesses by the same client within a prescribed time period, extracts service utilization routes taking them to be used within operations having the same objective.

9. The management server according to claim 7, wherein further:
a search condition for said service providing server is included in said access information;
there is comprised a data acquisition result receiving part acquiring, from said service providing server, search result information based on said search condition and associating, and storing in said memory part, said search result information and said access information; and
said utilization route extracting part judges whether the search condition is included or not in the previously used search result information, and in case the search condition is included in the previously used search result information, judges that it is used within operations having the same objective, and extracts the service utilization route.

10. The management server according to claim 7, further comprising:
a login and logout history information acquisition part acquiring a starting time at which said client starts a business operation and an ending time at which he ends it, with respect to a specific business application provided by said service providing server, and associating the same with said business application, and storing the same in said memory part;
and wherein:
said utilization route extracting part takes accesses of said client between said starting time and said ending time to be accesses to the same service providing server used within operations having the same objective, and extracts a service utilization route.

11. The management server according to claim 7, wherein,
if said management server receives, from said client, any one of an extraction request based on a path length being the total number of service providing servers of said service utilization route, an extraction request based on the utilization time of said service utilization route, and an extraction request based on said number of times of extraction,
said statistical information extracting part extracts said service utilization route on the basis of said extraction request.

12. The management server according to claim 7,
further comprising: a sales information acquisition part associating, and storing in said storage part, said access information, included in the request received by said data acquisition request receiving part, and sales information about the service;
and wherein:
said statistical information extracting part computes, on the basis of said sales information, the total service sales amount due to said service utilization route; and
said utilization route output information generating part associates said service utilization route and said total sales amount, and generates output information.

13. The management server according to claim 7, wherein:
said management server has customer information associated with sender information in said memory part; and
said statistical information extracting part computes, for each piece of customer information designated by said client, the number of times of extraction of service utilization routes that are the same as the service utilization route extracted with said utilization route extracting part.

14. The management server according to claim 13, wherein at least one of age, gender, and full name is included in said customer information.

15. A service utilization route output method which, in a system having a plurality of service providing servers providing services on a network and a management server accessing said service providing servers and managing the access situation of a client utilizing said services, outputs the utilization routes of said client; and
wherein, regarding said management server:
if a data acquisition request receiving part thereof receives a request sent from said client to one of said service providing servers,
a history information storage part thereof associates, and stores as access information in a memory part, sender information, recipient information, and the reception time at which said request was received, all included in said request;
a utilization route extracting part thereof extracts, on the basis of said access information, the service accessed by said client and a service utilization route being the sequence of said service;
a statistical information extracting part thereof computes the number of times of extraction of service utilization routes being the same as said extracted service utilization route; and
a utilization route output information generating part thereof associates said service utilization route and said number of times of extraction, and generates output information.

16. The service utilization route output method according to claim 15, wherein, regarding further said management server:
a sales information acquisition part thereof associates, and stores in said storage part, said access information included in said received request, and sales information about the service;
said statistical information extracting part thereof computes, on the basis of said sales information, the average sales amount and the total service sales amount due to said service utilization route; and
said utilization route output information generating part thereof associates said service utilization route with said average sales amount and said total sales amount, and generates output information.

17. A service utilization route output program wherein the service utilization route output method according to claim 15 is made to be executed by a computer.

18. A service utilization route output program wherein the service utilization route output method according to claim 16 is made to be executed by a computer.
